(19) United States
(12) Patent Application Publication
(10) Pub. No.: US 2016/0078465 A1
(43) Pub. Date: Mar. 17, 2016

(54) SYSTEMS AND METHODS FOR ENABLING SELECTION OF AVAILABLE CONTENT BASED ON REWARDS

(71) Applicant: OpenTV Inc., San Francisco, CA (US)

(72) Inventors: Crx CHAI, Oakland, CA (US); Alex FISHMAN, San Francisco, CA (US)

(21) Appl. No.: 14/851,190

(22) Filed: Sep. 11, 2015

Related U.S. Application Data
(60) Provisional application No. 62/048,930, filed on Sep. 11, 2014.

(51) Int. Cl. G06Q 30/02; G06F 3/0482; H04N 21/4784; G06F 3/0484; G06F 3/0485

(52) U.S. Cl. CPC G06Q 30/0226; G06F 3/04842; G06F 3/0485; H04N 21/4784; G06F 3/0482

(57) ABSTRACT

A device for enabling content selection is configured to present a graphical user interface enabling a user to earn reward points. The device is configured to present a graphical user interface enabling a user to redeem reward points. In one example, a graphical user interface enabling a user to earn reward points may include one or more cards associated with an item of content and each card may include a point value and an associated action required to earn the point value. In one example, a graphical user interface including one or more cards associated with a reward may include one or more cards associated with a reward and each card may include a point value required for a reward, a total number of available points, and a number of additional points required to receive the reward.

### RELATED APPLICATIONS

This application claims the benefit of U.S. Provisional Application No. 62/048,930, filed on Sep. 11, 2014, which is incorporated by reference in its entirety.

### TECHNICAL FIELD

The present disclosure relates to the field of interactive television and graphical user interfaces.

### BACKGROUND

Digital media playback capabilities may be incorporated into a wide range of devices, including digital televisions, including so-called “smart” televisions, laptop or desktop computers, tablet computers, e-book readers, personal digital assistants (PDAs), digital recording devices, digital media players, video gaming devices, digital cameras, cellular or satellite radio telephones, including so-called “smart” phones, dedicated video streaming devices, and the like. Digital media content may originate from a plurality of sources including, for example, over-the-air television providers, satellite television providers, cable television providers, online media-sharing services, including, online media streaming and downloading services, peer devices, and the like. Further, devices with digital media playback capabilities may be configured to output digital media to ultra-resolution displays.

Due to the wide range of content users may access on devices with digital media playback capabilities, traditional techniques for the organizing, sorting, and displaying available content choices may be less than ideal, particularly for televisions and secondary connected devices. Further, traditional electronic programming guides may be less than ideal for allowing users to earn points and redeem rewards.

### SUMMARY

The following brief summary is not intended to include all features and aspects of the present invention, nor does it imply that the invention must include all features and aspects discussed in this summary. The present disclosure relates to the field of graphical user interfaces and more specifically describes techniques for presenting a user with dynamic interactive graphical user interfaces. In particular, this disclosure describes techniques for enabling users to earn and redeem points. In some examples, the techniques may be implemented in a device with digital media playback capabilities, including for example, laptop or desktop computers, tablet computers, smart phones, set top boxes, and televisions.

According to one example of the disclosure, a method of enabling a user to earn reward points, comprises providing a graphical user interface including a plurality of cards, wherein each of the plurality of cards is associated with an item of content and wherein each of the plurality of cards includes a point value and an associated action required to earn the point value, wherein the graphical user interface is presented to a user upon a user selecting an earn points card from a graphical user interface including a profile card, an earn points card, and a redeem card, and updating an account associated with the user upon an associated action being completed.

According to another example of the disclosure, a device comprises one or more processors configured to provide a graphical user interface including a plurality of cards, wherein each of the plurality of cards is associated with an item of content and wherein each of the plurality of cards includes a point value and an associated action required to earn the point value, wherein the graphical user interface is presented to a user upon a user selecting an earn points card from a graphical user interface including a profile card, a earn points card, and a redeem card, and update an account associated with the user upon an associated action being completed.

According to another example of the disclosure, a non-transitory computer-readable storage medium has instructions stored thereon that upon execution cause one or more processors of a device to provide a graphical user interface including a plurality of cards, wherein each of the plurality of cards is associated with an item of content and wherein each of the plurality of cards includes a point value and an associated action required to earn the point value, wherein the graphical user interface is presented to a user upon a user selecting an earn points card from a graphical user interface including a profile card, a earn points card, and a redeem card, and update an account associated with the user upon an associated action being completed.

According to another example of the disclosure, an apparatus comprises means for providing a graphical user interface including a plurality of cards, wherein each of the plurality of cards is associated with an item of content and wherein each of the plurality of cards includes a point value and an associated action required to earn the point value, wherein the graphical user interface is presented to a user upon a user selecting an earn points card from a graphical user interface including a profile card, a earn points card, and a redeem card, and means for updating an account associated with the user upon an associated action being completed.

According to another example of the disclosure, a method of enabling a user to redeem reward points comprises providing a graphical user interface including a plurality of cards, wherein each of the plurality of cards is associated with a reward and wherein each of the plurality of cards includes a point value required for a reward, a total number of available points, and a number of additional points required to receive the reward, and upon a user selecting a card associated with a reward, providing a graphical user interface providing more information associated with the reward.

According to another example of the disclosure, a device comprises one or more processors configured to provide a graphical user interface including a plurality of cards, wherein each of the plurality of cards is associated with a reward and wherein each of the plurality of cards includes a point value required for a reward, a total number of available points, and a number of additional points required to receive the reward, and upon a user selecting a card associated with a reward, and provide a graphical user interface providing more information associated with the reward.

According to another example of the disclosure, a non-transitory computer-readable storage medium has instructions stored thereon that upon execution cause one or more processors of a device to provide a graphical user interface including a plurality of cards, wherein each of the plurality of cards is associated with a reward and wherein each of the plurality of cards includes a point value required for a reward, a total number of available points, and a number of additional points required to receive the reward, and upon a user selecting a card associated with a reward, and provide a graphical user interface providing more information associated with the reward.

According to another example of the disclosure, an apparatus comprises means for providing a graphical user interface including a plurality of cards, wherein each of the plurality of cards is associated with a reward and wherein each of the plurality of cards includes a point value required for a reward, a total number of available points, and a number of additional points required to receive the reward, and means for upon a user selecting a card associated with a reward, providing a graphical user interface providing more information associated with the reward.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is block diagram illustrating an example of a system that may implement one or more techniques of this disclosure.

FIG. 2 is a block diagram illustrating an example of a computing device that may implement one or more techniques of this disclosure.

FIG. 3 is a conceptual diagram illustrating an example of an input/output device that may implement one or more techniques of this disclosure.

FIG. 4 is a conceptual diagram illustrating example navigational paths to example graphical user interfaces in accordance with one or more techniques of this disclosure.

FIG. 5 is a conceptual diagram illustrating an example of a graphical user interface in accordance with one or more techniques of this disclosure.

FIG. 6 is a conceptual diagram illustrating an example of a graphical user interface in accordance with one or more techniques of this disclosure.

FIGS. 7A-7C are conceptual diagrams illustrating an example of a graphical user interface in accordance with one or more techniques of this disclosure.

FIGS. 8A-8D are conceptual diagrams illustrating an example of a graphical user interface in accordance with one or more techniques of this disclosure.

FIG. 9A-9D are conceptual diagrams illustrating an example of a graphical user interface in accordance with one or more techniques of this disclosure.

FIG. 10A-10C are conceptual diagrams illustrating an example of a graphical user interface in accordance with one or more techniques of this disclosure.

FIG. 11 is a conceptual diagram illustrating an example of a graphical user interface in accordance with one or more techniques of this disclosure.

FIG. 12A-12D are conceptual diagrams illustrating an example of a graphical user interface in accordance with one or more techniques of this disclosure.

FIG. 13A-13C are conceptual diagrams illustrating an example of a graphical user interface in accordance with one or more techniques of this disclosure.

### DETAILED DESCRIPTION

Described herein are systems and methods for enabling users to earn and redeem points. Some embodiments extend to a machine-readable medium embodying instructions which, when executed by a machine, cause the machine to perform any one or more of the methodologies described herein. Other features will be apparent from the accompanying drawings and from the detailed description that follows. Examples merely typify possible variations. Unless explicitly stated otherwise, components and functions are optional and may be combined or subdivided, and operations may vary in sequence or may be combined or subdivided. In the following description, for purposes of explanation, numerous specific details are set forth to provide a thorough understanding of example embodiments. It will be evident to one skilled in the art, however, that the present subject matter may be practiced without these specific details.

Devices with digital media playback capabilities, including, for example, televisions, set top boxes, and mobile devices, may be configured to provide users thereof with graphical user interfaces that enable users to select content. In some examples, these graphical user interfaces may be referred to as electronic program guides (EPGs). Traditional electronic program guides may include graphical user interfaces that arrange content in a grid configuration based on a television network identifier and timeslots. Traditional electronic program guides may not be configured to enable a user to earn and redeem reward points.

The techniques described herein provide graphical user interfaces that enable a user to earn and redeem reward points. The example graphical user interfaces described herein display items of content and point earning opportunities. Further, the example graphical user interfaces enable a user to purchase rewards and items of content using a combination of earned points and a currency.

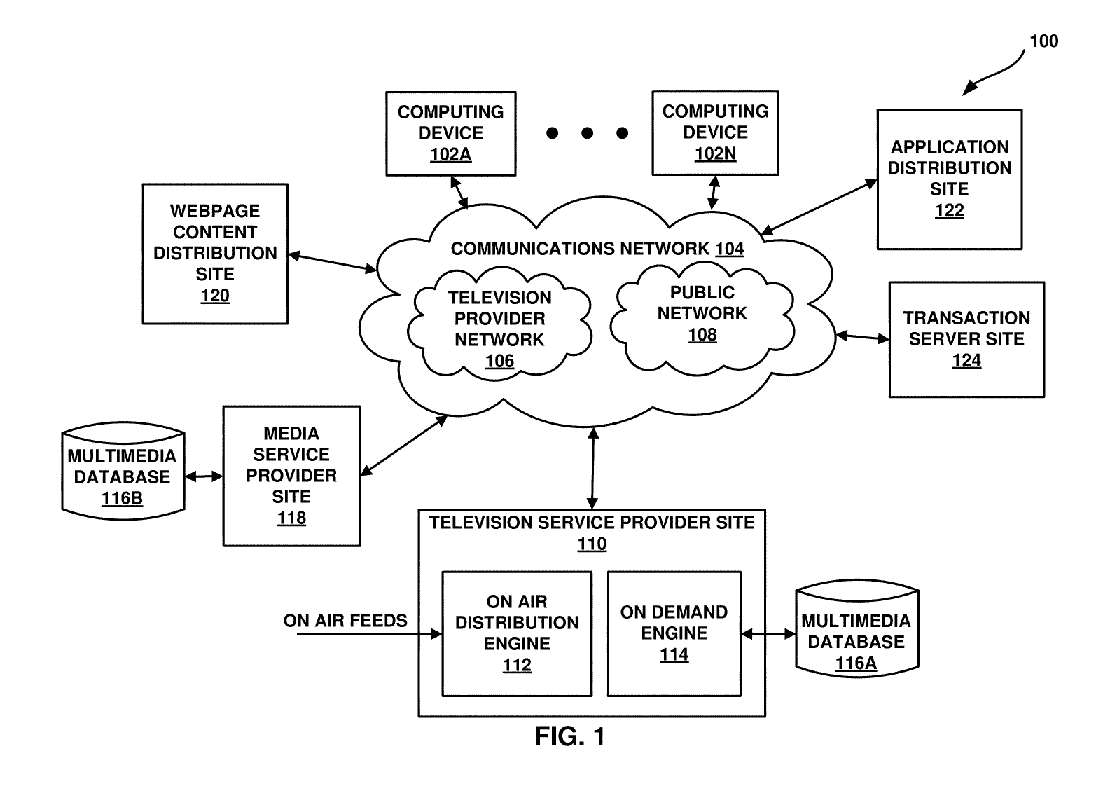

FIG. 1 is block diagram illustrating an example of a system that may implement one or more techniques described in this disclosure. System 100 may be configured to enable content selection in accordance with the techniques described herein. In the example illustrated in FIG. 1, system 100 includes one or more computing devices 102A-102N, communications network 104, television service provider site 110, media service provider site 118, webpage content distribution site 120, application distribution site 122, and transaction server site 124. System 100 may include software modules operating on one or more servers. Software modules may be stored in a memory and executed by a processor. Servers may include one or more processors and a plurality of internal and/or external memory devices. Examples of memory devices include file servers, file transfer protocol (FTP) servers, network attached storage (NAS) devices, local disk drives, or any other type of device or storage medium capable of storing data. Storage medium may include Blu-ray discs, DVDs, CD-ROMs, flash memory, or any other suitable digital storage media. When the techniques described herein are implemented partially in software, a device may store instructions for the software in a suitable, non-transitory computer-readable medium and execute the instructions in hardware using one or more processors.

System 100 represents an example of a system that may be configured to allow digital content, such as, for example, music, videos, images, webpages, messages, voice communications, and applications, to be distributed to and accessed by a plurality of computing devices, such as computing devices 102A-102N. In the example illustrated in FIG. 1, computing devices 102A-102N may include any device configured to transmit data to and/or receive data from communication network 104. For example, computing devices 102A-102N may be equipped for wired and/or wireless communications and may include set top boxes, digital video recorders, televisions, desktop, laptop, or tablet computers, gaming consoles, mobile devices, including, for example, “smart” phones, cellular telephones, and personal gaming devices. It should be noted that although example system 100 is illustrated as having distinct sites, such an illustration is for descriptive purposes and does not limit system 100 to a particular physical architecture. Functions of system 100 and sites included therein may be realized using any combination of hardware, firmware and/or software implementations.

Communications network 104 may comprise any combination of wireless and/or wired communication media. Communications network 104 may include coaxial cables, fiber optic cables, twisted pair cables, wireless transmitters and receivers, routers, switches, repeaters, base stations, or any other equipment that may be useful to facilitate communications between various devices and sites. Communications network 104 may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and IEEE standards, such as, for example, one or more of the IEEE 802 standards.

As illustrated in FIG. 1, networks of different types may be defined within communications network 104. Networks may be defined according to physical and/or logical aspects. For example, networks that share the same physical infrastructure (e.g., coaxial cables) may be distinguished based on a primary service type (e.g., webpage access or television service). Physical and logical aspects of networks may be described according to a layered model. For example, layers of a model may respectively define physical signaling, addressing, channel access control, packet properties, and data processing in a communications system. One example of a layered model is the Open Systems Interconnection (OSI) model. In the example illustrated in FIG. 1, communications network 104 includes television provider network 106 and public network 108. It should be noted that although television provider network 106 and public network 108 are illustrated as distinct, television provider network 106 and public network 108 may share physical and/or logical aspects.

Television provider network 106 is an example of a network configured to provide a user with television services. For example, television provider network 106 may include public over-the-air television networks, public or subscription-based satellite television service provider networks, and public or subscription-based cable television provider networks. It should be noted that although in some examples television provider network 106 may primarily be used to provide television services, television provider network 106 may also provide other types of data and services according to any combination of the telecommunication protocols described herein.

Public network 108 is an example of a packet-based network, such as, a local area network, a wide-area network, or a global network, such as the Internet, configured to provide a user with World Wide Web based services. Public network 108 may be configured to operate according to Internet Protocol (IP) standards. It should be noted that although in some examples public network 108 may primarily be used to provide access to hypertext web pages, public network 108 may also provide other types of media content according to any combination of the telecommunication protocol described herein.

Referring again to FIG. 1, television service provider site 110 may be configured to provide computing devices 102A-102N with television service. For example, television service provider site 110 may be a public broadcast station, a cable television provider, or a satellite television provider, etc., and may be configured to provide television services to analog and/or digital televisions and set top boxes. In the example illustrated in FIG. 1, television service provider site 110 includes on air distribution engine 112 and on demand engine 114. On air distribution engine 112 may be configured to receive a plurality of on air feeds and distribute the feeds to computing devices 102A-102N through television provider network 106. For example, on air distribution engine 112 may be configured to receive one or more over-the-air television broadcasts via a satellite uplink/downlink and distribute the over-the-air television broadcasts to one or more users of a subscription-based cable television service.

On demand engine 114 may be configured to access a multimedia library and distribute multimedia content to one or more of computing devices 102A-102N through television provider network 106. For example, on demand engine 114 may access multimedia content (e.g., music, movies, and TV shows) stored in multimedia database 116A and provide a subscriber of a cable television service with movies on a Pay Per View (PPV) basis. Multimedia database 116A may be a storage device configured to store multimedia content. It should be noted that multimedia content accessed through on demand engine 114 may also be located at various sites within system 100 (e.g., peer-to-peer distribution, etc.).

Media service provider site 118 represents an example of a multimedia service provider. Media service provider site 118 may be configured to access a multimedia library and distribute multimedia content to one or more of computing devices 102A-102N through public network 108. For example, media service provider site 118 may access multimedia (e.g., music, movies, and TV shows) stored in multimedia database 116B and provide a user of a media service with multimedia. In some examples, multimedia may include live events (e.g., sporting events) and/or currently airing television programs. Multimedia database 116B may be a storage device configured to store multimedia content. In one example, media service provider site 118 may be configured to provide content to one or more of computing devices 102A-102N using the Internet protocol suite. In some examples, a media service may be referred to as a streaming service. Commercial examples of media services may include Hulu®, YouTube®, Netflix®, Amazon Prime®, and television network based streaming services (e.g. WatchESPN®). As described above, television provider network 106 and public network 108 may share physical and logical aspects. Thus, content accessed by one or more of computing devices 102A-102N through media service provider site 118 may be transmitted through physical components of television provider network 106. For example, a user of a computing device may access the internet and multimedia content provided by a media service through a cable modem connected to a coaxial network maintained by a cable television provider.

Webpage content distribution site 120 represents an example of a webpage service provider. Webpage content distribution site 120 may be configured to provide hypertext based content to one or more of computing devices 102A-102N through public network 108. It should be noted that hypertext based content may include audio and video content. Hypertext content may be defined according to programming languages, such as, for example, Hypertext Markup Language (HTML), Dynamic HTML, and Extensible Markup Language (XML). Examples of webpage content distribution sites include the Wikipedia website and the United States Patent and Trademark Office website. Further, webpage content may include ecommerce websites.

Application distribution site 122 represents an example of an application distribution service. Application distribution site 122 may be configured to distribute developed software applications to one or more of computing devices 102A-102N. In one example, software applications may include games and programs operable on computing devices. In other examples, software applications may be configured to allow a computing device to access content provided by a site in manner specific to the computing device. For example, software applications may be configured to provide enhanced or reduced functionality of a webpage to a mobile device or a set top box. Software applications may be developed using a specified programming language. Examples of programming languages include, ActionScript®, Java™, Jini™, C, C++, Perl, Python′, UNIX Shell, Visual Basic®, and Visual Basic® Script. In some examples, developers may write software applications using a software development kit (SDK) provided by a device manufacturer or a service provider. In the example where one or more of computing devices 102A-102N are mobile devices, application distribution site 122 may be maintained by a mobile device manufacturer, a service provider, and/or a mobile device operating system provider. In the example where one or more of computing devices 102A-102N are set top boxes, application distribution site 108 may be maintained by a set top box manufacturer, a service provider, and/or an operating system provider. In some examples, an application distribution site may be referred to as an app store. Examples of commercially available application distribution sites include Google Play™, the Apple App Store™, BlackBerry World®, Windows Phone® Store, and the Amazon® Appstore. In one example, application distribution site 122 may distribute the example reward applications described herein.

Transaction server site 124 represents an example of a site configured to enable a user to engage in an online transaction. For example, transaction site 124 be configured to enable a user to purchase a product or service through a website. Further, transaction site 124 may enable a user of a computing device to purchase items of content using a credit card account with associated reward points, as described in detail below. In one example, transaction site 124 may enable a credit card transaction to occur. In one example, transaction site 124 may include a payment processing center and a private financial network. The private financial network may enable a merchant bank or a third party processor to communicate with a credit card holder's bank. Transaction site 124 may be configured to perform functions associated with authorization and/or settlement/funding. In one example, transaction site 124 may operate in conjunction with television service provider site 110 and/or media service provider site 118 in order to enable a user to purchase multimedia content and or redeem reward points. For example, television service provider site 110 and/or media service provider site 118 may include databases storing user profile and/or account information. In one example, transaction site 124 may be configured to fund a virtual wallet for use with respect to purchasing content available from television service provider site 110 and/or media service provider site 118. It should be noted that, the techniques described herein may be generally applicable to any of various types of ecommerce implementation.

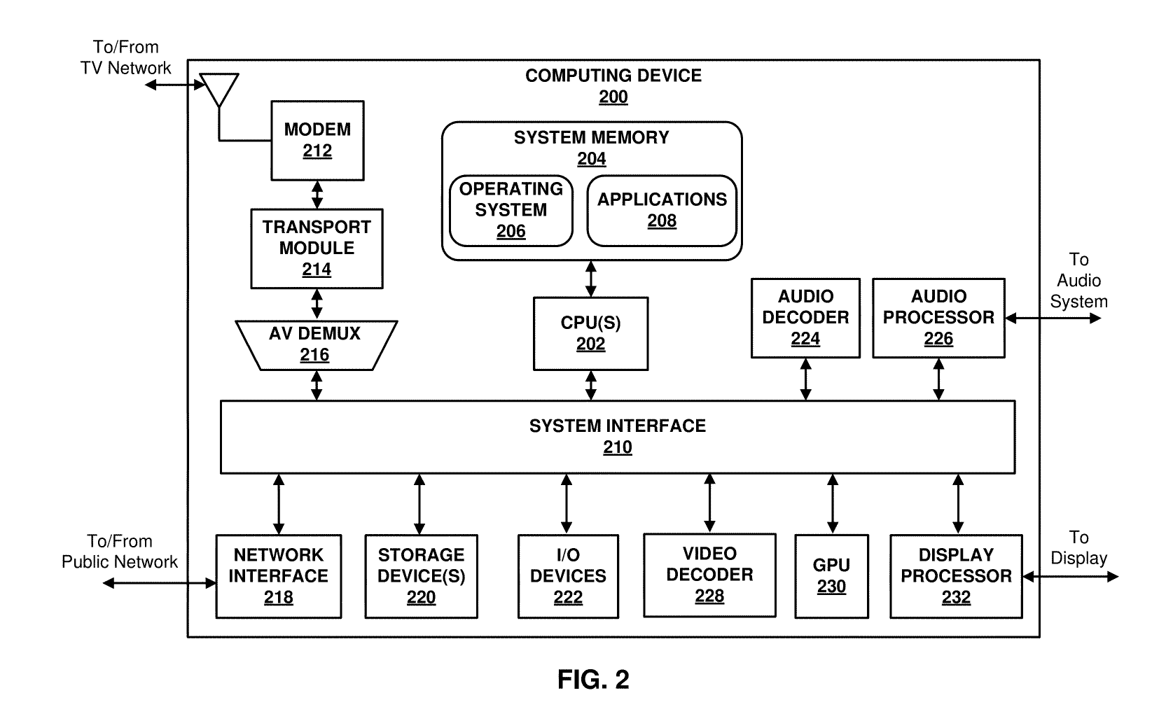

FIG. 2 is a block diagram illustrating an example of a computing device that may implement one or more techniques of this disclosure. Computing device 200 is an example of a computing device that may be configured to transmit data to and receive data from a communications network, allow a user to access multimedia content, and execute one or more applications. Computing device 200 may include or be part of a stationary computing device (e.g., a desktop computer, a television, a set-top box, a gaming console, a dedicated multimedia streaming device, a digital video recorder, etc.), a portable computing device (e.g., a mobile phone, a laptop, a personal data assistant (PDA), a tablet device, etc.) or another type of computing device. In the example illustrated in FIG. 2, computing device 200 is configured to send and receive data via a television network, such as, for example, television provider network 106 described above and send and receive data via a public network, such as, for example, public network 108. It should be noted that in other examples, computing device 200 may be configured to send and receive data through one of television provider network 106 or a public network 108. The techniques described herein may be utilized by devices configured to communicate using any and all combinations of communications networks.

As illustrated in FIG. 2, computing device 200 includes central processing unit(s) (CPU(S)) 202, system memory 204, system interface 210, modem 212, transport module 214, AV demux 216, network interface 218, storage device(s) 220, I/O devices 222, audio decoder 224, audio processor 226, video decoder 228, graphics processing unit (GPU) 230, and display processor 232. As illustrated in FIG. 2, system memory 204 includes operating system 206 and applications 208. Each of processor(s) 202, system memory 204, system interface 210, modem 212, transport module 214, AV demux 216, network interface 218, storage device(s) 220, I/O devices 222, audio decoder 224, audio processor 226, video decoder 228, graphics processing unit 230, and display processor 232 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although example computing device 200 is illustrated as having distinct functional blocks, such an illustration is for descriptive purposes and does not limit computing device 200 to a particular hardware architecture. Functions of computing device 200 may be realized using any combination of hardware, firmware and/or software implementations.

Central processing unit(s) 202 may be configured to implement functionality and/or process instructions for execution in computing device 200. Central processing unit(s) 202 may be capable of retrieving and processing instructions, code, and/or data structures for implementing one or more of the techniques described herein. Instructions may be stored on a computer readable medium, such as system memory 204 or storage devices 220. Central processing unit(s) 202 may include multi-core central processing units.

System memory 204 may be described as a non-transitory or tangible computer-readable storage medium. In some examples, system memory 204 may provide temporary and/or long-term storage. In some examples, system memory 204 or portions thereof may be described as non-volatile memory and in other examples portions of system memory 204 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories.

System memory 204 may be configured to store information that may be used by computing device 200 during operation. System memory 204 may be used to store program instructions for execution by central processing unit(s) 202 and may be used by software or applications running on computing device 200 to temporarily store information during program execution. For example, system memory 204 may store instructions associated with operating system 206 and applications 208. Applications 208 may include applications implemented within or executed by computing device 200 and may be implemented or contained within, operable by, executed by, and/or be operatively/communicatively coupled to components of computing device 200. Applications 208 may include instructions that may cause central processing unit(s) 202 of computing device 200 to perform particular functions. Applications 208 may include algorithms which are expressed in computer programming statements, such as, for-loops, while-loops, if-statements, do-loops, etc. Applications 208 may be distributed to computing device 200 through an application distribution site, such as, for example, application distribution site 122 described above. In one example, applications 208 may include example reward applications described herein.

As further illustrated in FIG. 2, applications 208 may execute in conjunction with operating system 206. That is, operating system 206 may be configured to facilitate the interaction of applications 208 with central processing unit(s) 202, and other hardware components of computing device 200. It should be noted that in some examples, components of operating system 206 and components acting in conjunction with operating system 206 may be referred to as middleware. The techniques described herein may be utilized by devices configured to operate using any and all combinations of software architectures. Operating system 206 may be an operating system designed to be installed on laptops, desktops, smartphones, tablets, set-top boxes, digital video recorders, televisions and/or gaming devices. In one example, operating system 206 may include one or more of operating systems or middleware components developed by OpenTV®, Windows® operating systems, Linux operation systems, Mac OS® operating systems, Android® operating systems, and any and all combinations thereof.

System interface 210, may be configured to enable communications between components of computing device 200. In one example, system interface 210 comprises structures that enable data to be transferred from one peer device to another peer device or to a storage medium. For example, system interface 210 may include a chipset supporting Accelerated Graphics Port (AGP) based protocols, Peripheral Component Interconnect (PCI) bus based protocols, such as, for example, the PCI Express' (PCIe) bus specification, which is maintained by the Peripheral Component Interconnect Special Interest Group, or any other form of structure that may be used to interconnect peer devices.

Storage device(s) 220 represent memory of computing device 200 that may be configured to store relatively larger amounts of information for relatively longer periods of time than system memory 204. For example, in the example where computing device 200 is included as part of a digital video recorder, storage device(s) 220 may be configured to store numerous video files. Similar to system memory 204, storage device(s) 220 may also include one or more non-transitory or tangible computer-readable storage media. Storage device(s) 220 may include internal and/or external memory devices and in some examples may include volatile and non-volatile storage elements. Examples of memory devices include file servers, an FTP servers, NAS devices, a local disk drive, or any other type of device or storage medium capable of storing data. Storage medium may include Blu-ray discs, DVDs, CD-ROMs, flash memory, or any other suitable digital storage media.

I/O devices 222 may be configured to receive input and provide output during operation of computing device 200. Input may be generated from an input device, such as, for example, a push-button remote control, a motion based remote control, a device including a touch-sensitive screen, a device including a track pad, a mouse, a keyboard, a microphone, a video camera, a motion sensor, or any other type of device configured to receive user input. In one example, an input device may include an advanced user input device, such as a smart phone or a tablet computing device. For example, an input device may be a secondary computing device and may be configured to receive user input via touch gestures, buttons on the secondary computing device, and/or voice control. Further, in some examples, an input device may include a display that is configured to display the graphical users interfaces described herein. For example, in the case where computing device 200 includes a television, an input device may include a smart phone in communication with the television. In this example, a user may provide commands to a television by activating portions of a graphical user interface displayed on a smart phone. Output may be provided to output devices, such as, for example internal speakers, an integrated display device, and/or external components, such as, a secondary computing device. In some examples, I/O device(s) 222 may be operatively coupled to computing device 200 using a standardized communication protocol, such as for example, Universal Serial Bus protocol (USB), Bluetooth®, ZigBee® or a proprietary communications protocol, such as, for example, a proprietary infrared communications protocol.

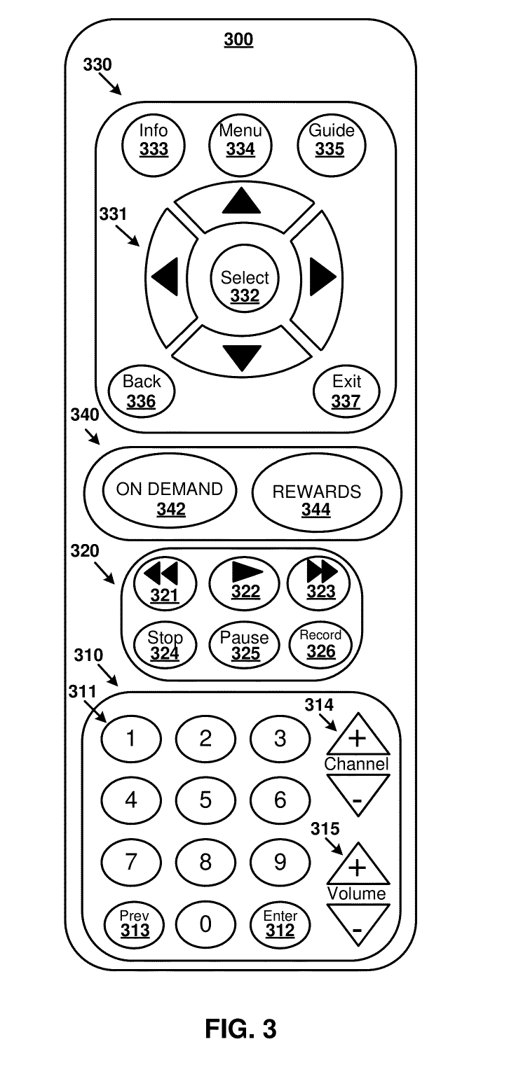

FIG. 3 is a conceptual diagram illustrating an example of an input/output device that may implement one or more techniques of this disclosure. In the example illustrated in FIG. 3, I/O device 300 is illustrated as a push-button remote control. It should be noted that while I/O device 300 is illustrated as a push-button remote control in the example illustrated in FIG. 3, in other examples, the functionality of I/O device 300 may be implemented using other I/O devices, such as, for example, a secondary computing device in communication with a primary computing device. Further, in other examples, functions achieved by activation of buttons of I/O device 300 may be achieved through other types of user inputs. For example, in the case where an I/O device includes a touchscreen, gesture recognition, and/or voice recognition, virtual buttons may be presented on the touchscreen and functions achieved by activation of buttons on I/O device 300 may be achieved through any and all combinations of virtual button activation, motion gestures, and/or voice commands. In one example, an I/O device may have voice recognition capabilities and a function achieved by activation of rewards button 344 may be achieved by a user saying “rewards,” or a similar phrase.

In the example illustrated in FIG. 3, I/O device 300 includes basic television controls 310, playback controls 320, navigational controls 330, and shortcut controls 340. Basic television controls 310 may be configured to enable a user to perform basic tuning and volume control functions associated with viewing television programming. As illustrated in FIG. 3, basic television controls 310 include numeric keypad 311, enter button 312, previous channel button 313, channel change buttons 314, and volume control buttons 315. Numeric keypad 311, enter button 312, previous channel button 313, and channel change buttons 314 may be configured to enable a user to tune to a particular analog and/or digital channel. Upon a user entering a sequence of numbers using numeric keypad 311 and, optionally, additionally activating enter key 312, a tuner, for example an ATSC or DVB tuner, may tune to a specified channel. Upon activation of previous channel button 313, a tuner may tune to a previously tuned channel. Activation of “+” and “−” channel buttons 314 may respectively cause a tuner to tune to the respective next channel in a sequence of channels. Activation of “+” and “−” volume control buttons 315 may respectively cause the output of an audio system to be increased or decreased. It should be noted that although the basic television controls 310 may be configured to enable a user to perform basic tuning and volume control functions associated with a television, set-top box, or the like, in some examples, basic television controls 310 may be used to perform other functions associated with a computing device. For example, in the case where a graphical user interface is presented to a user, activation of “+” and “−” channel buttons 314 may cause respective scroll up and scroll down functions to be performed.

Playback controls 320 may be configured to enable a user to control the playback of and/or record multimedia content. For example, playback controls 320 may enable a user to control the playback of a video originating from a media service provider site, an on demand engine, and/or a personal video recorder (PVR). As illustrated in FIG. 3, playback controls 320 include reverse playback button 321, normal playback button 322, forward playback button 323, stop playback button 324, pause playback button 325, and record button 326. Reverse playback button 321 may enable to a user to navigate to a previous point in a multimedia sequence. Upon activation, normal playback button 322 may cause normal playback of an item of multimedia content to begin or resume. Forward playback button 323 may enable a user to navigate to a future point in a multimedia sequence. Upon activation, stop playback button 324 may cause the playback of an item of multimedia content to cease. Upon activation, pause playback button 325 may cause the playback of an item of multimedia content to be paused. Record button 326 may enable a user to cause an item of multimedia content to be stored on a storage device. It should be noted that although playback controls 320 may be configured to enable a user to control the playback of and/or record multimedia content, in some examples playback controls 320 may be used to perform other functions associated with a computing device. For example, in the case where a graphical user interface is presented to a user, activation of reverse playback button 321 and forward playback button 323 may cause respective scroll right and scroll left functions to be performed.

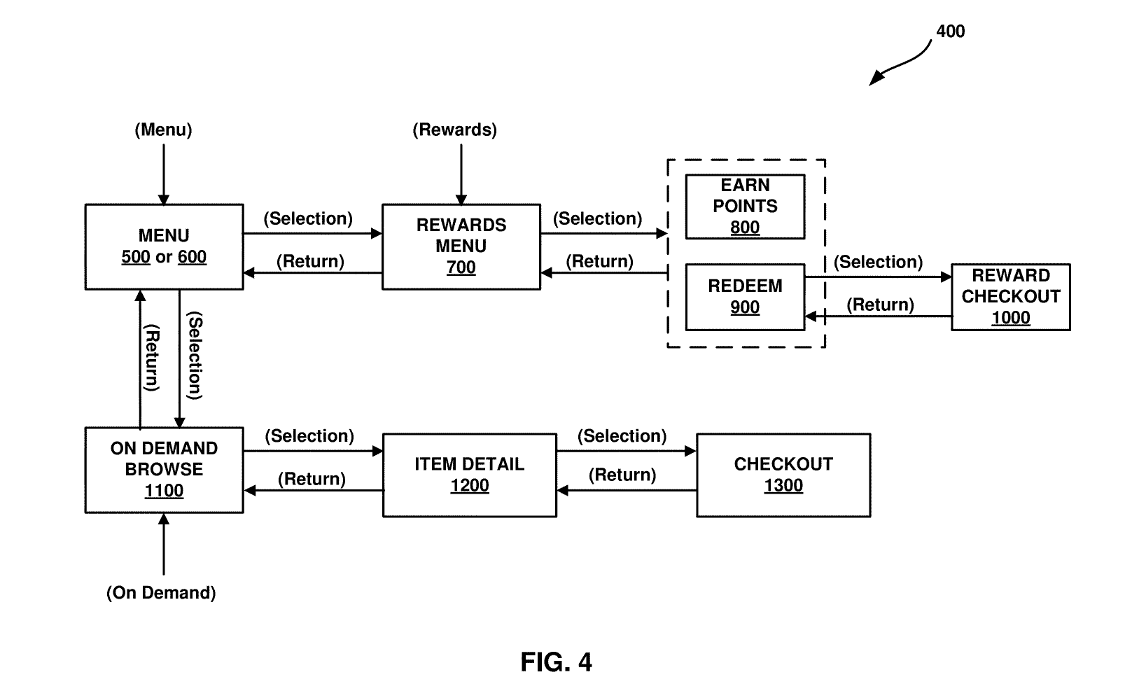

As described above, devices with digital media playback capabilities, including, for example, televisions, set top boxes, and mobile devices, may be configured to provide users thereof with graphical user interfaces that enable the selection of content. Navigational controls 330 may be configured to enable a user to navigate graphical user interfaces and select items using a graphical user interface. In one example, navigational controls 330 may enable a user to navigate and select item from one of more of the example graphical user interfaces described below with respect to FIGS. 4-13C.

In the example illustrated in FIG. 3, navigational controls 330 include navigational arrow buttons 331, select button 332, information button 333, menu button 334, guide button 335, back button 336, and exit button 337. Navigational arrow buttons 331 may be configured to move the position of a cursor and other visual elements associated with a graphical user interface and/or change the selection of an item included in a graphical user interface. For example, navigational arrow buttons 331 may enable the user to change the selection of an icon in an electronic programming guide representing a television program (e.g., change selected item in a grid guide). As described in detail below, in one example, activation of navigational arrow buttons 331 may cause the initial selection of one of the panes described below.

Select button 332 may enable a user to further select an item after an initial selection has occurred. As described in detail below, an icons, panes, and the like may be associated with multiple levels of selection. In one example, consecutive activations of select button 332 may cause respective levels of selection to occur. Information button 333 may be configured to cause additional information associated with an item to be displayed. For example, when an icon representing an item of content is initially selected, activation of information button 333 may cause information associated with the content (e.g., cast and crew information) to be displayed.

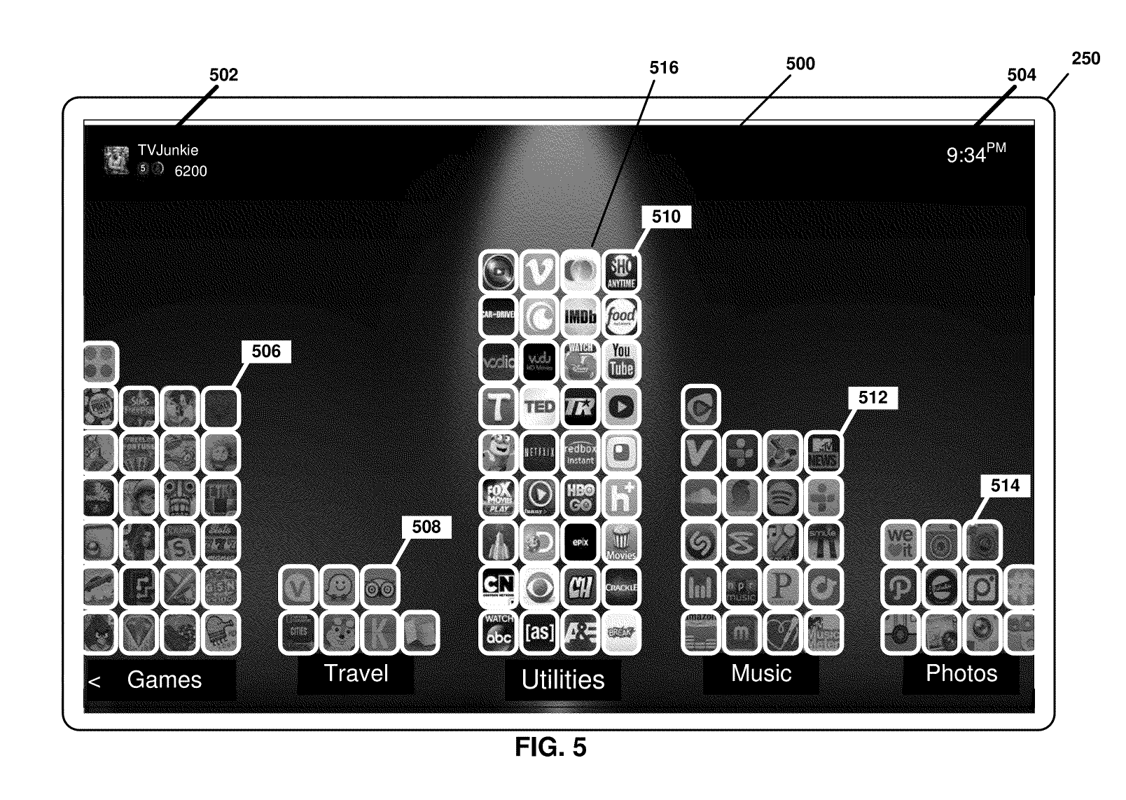

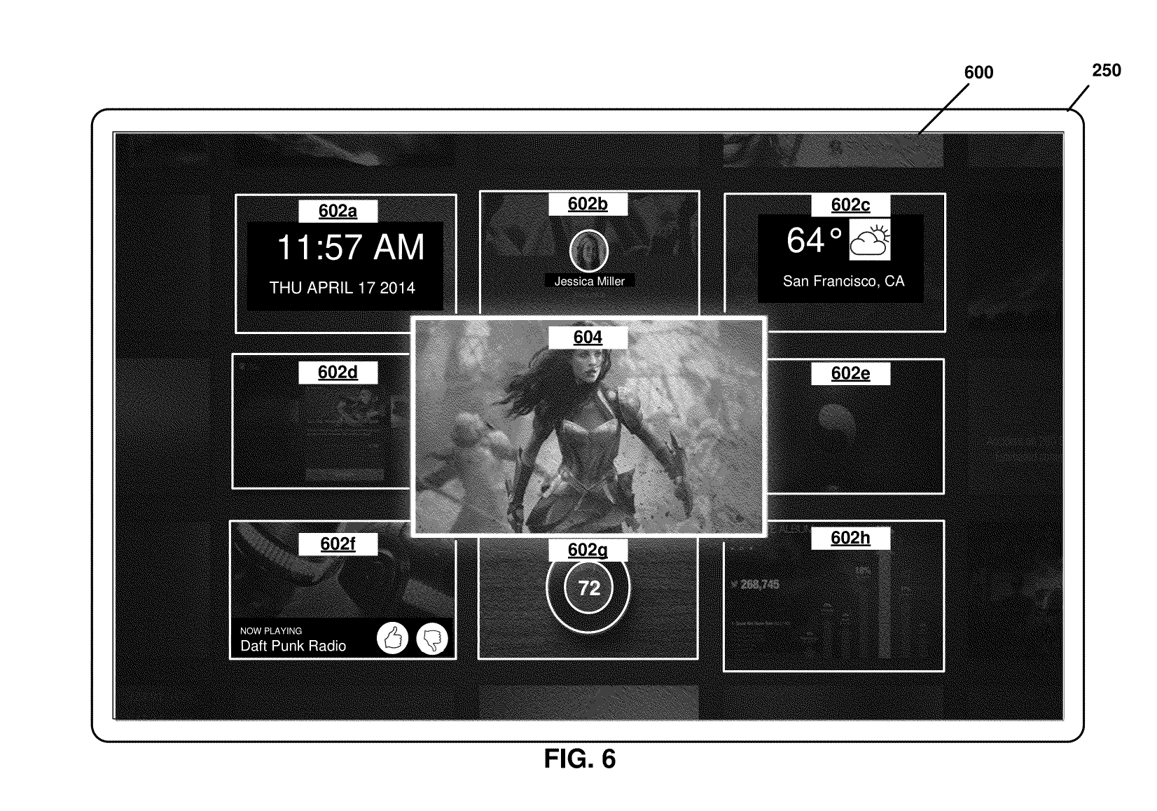

Menu button 334, guide button 335, back button 336, and exit button 337 may be configured to enable a user to cause different graphical user interfaces to be presented. Upon activation, menu button 334 may cause a graphical user interface including a high level menu to be displayed. In one example, a high level menu may include a menu that enables a user to change settings associated with the operation of a computing device. In one example, a high-level menu may include a menu that enables a user to select a user profile (e.g., a log-in graphical user interface). In one example, upon activation of menu button 334, graphical user interface 500 described below with respect to FIG. 5 or graphical user interface 600 described below with respect to FIG. 6 may be presented on a display. Upon activation, guide button 335 may be configured to provide a graphical user interface that enables a user to select content. For example, in one example, activation of guide button 335 may cause a grid guide to be presented.

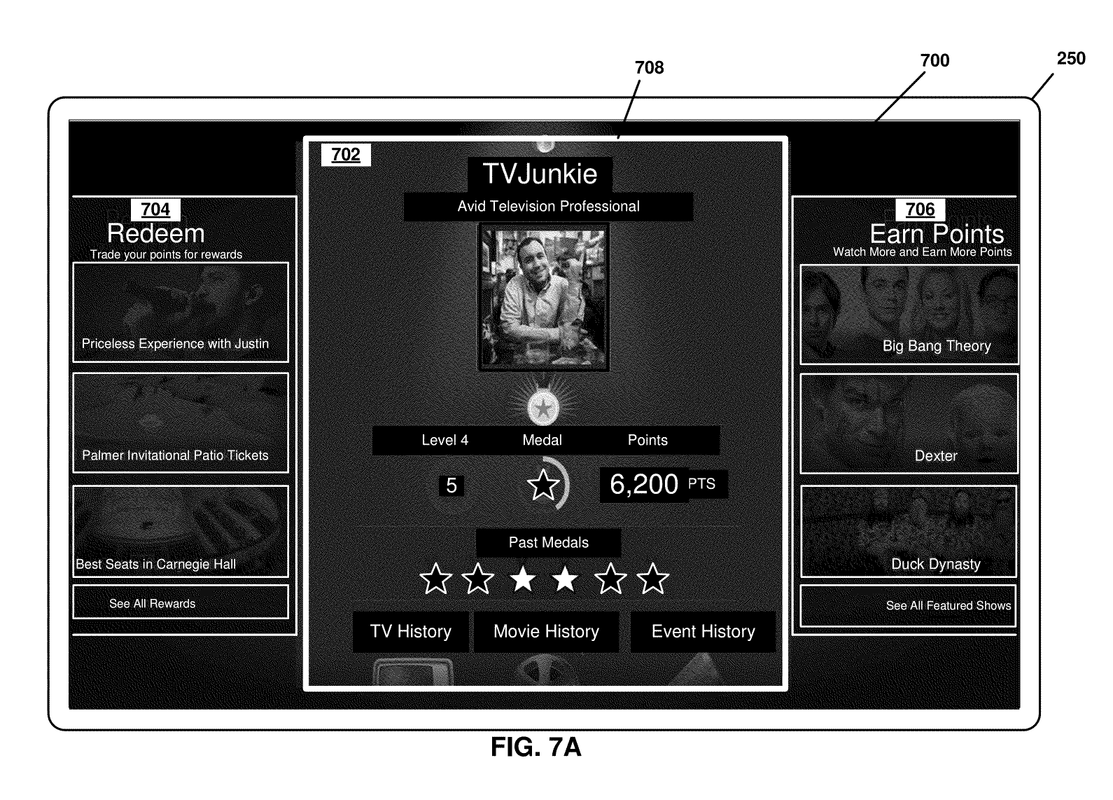

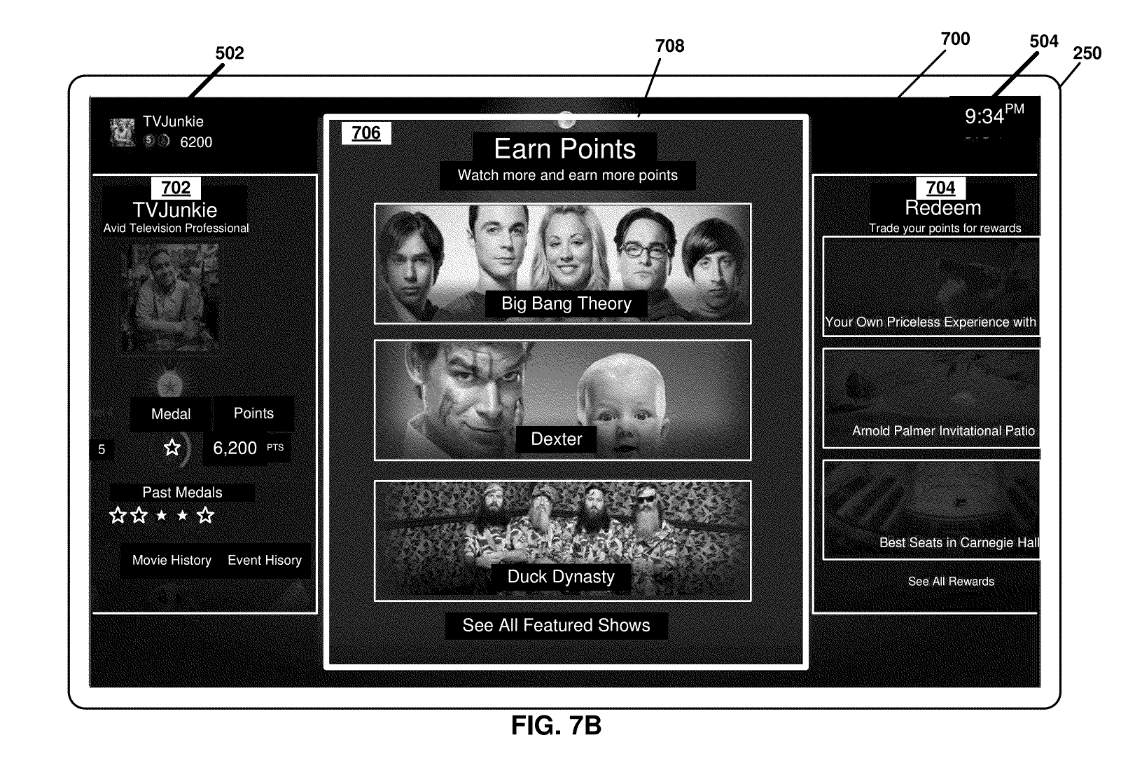

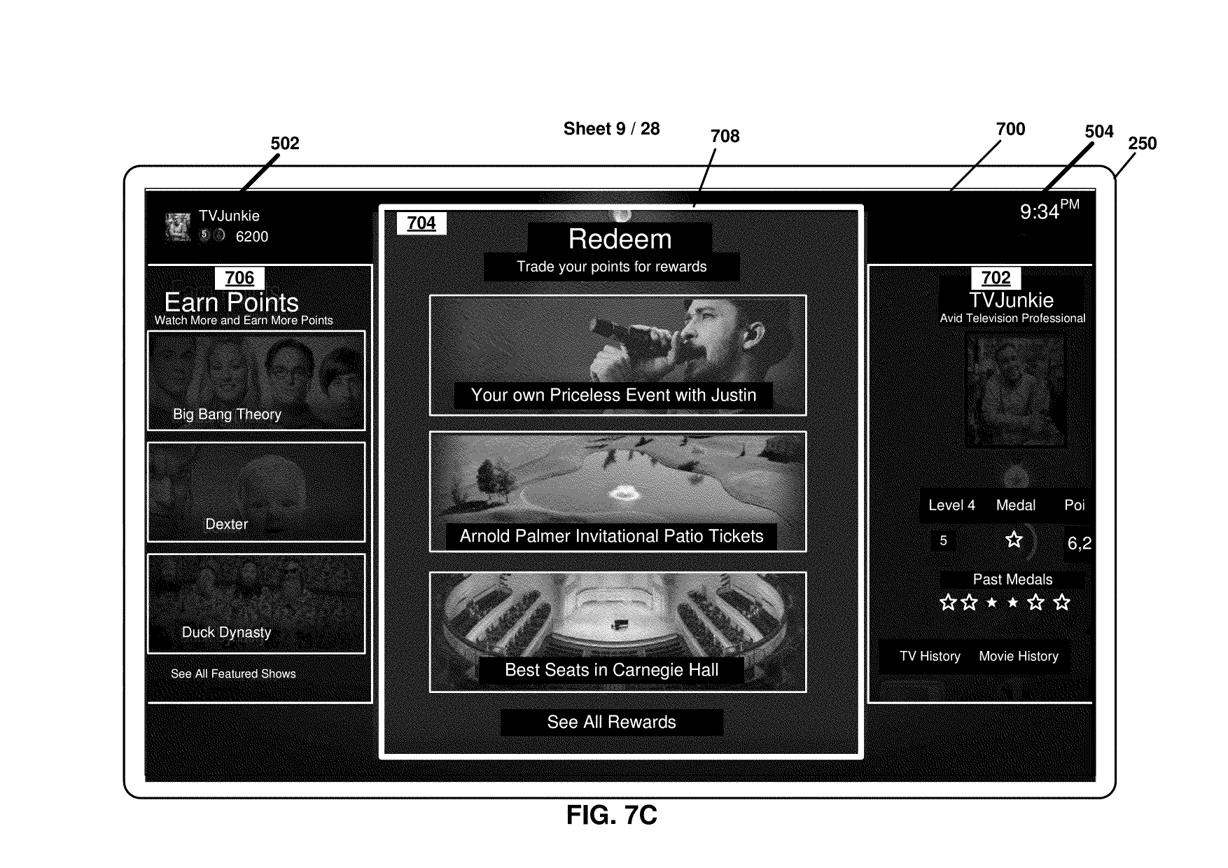

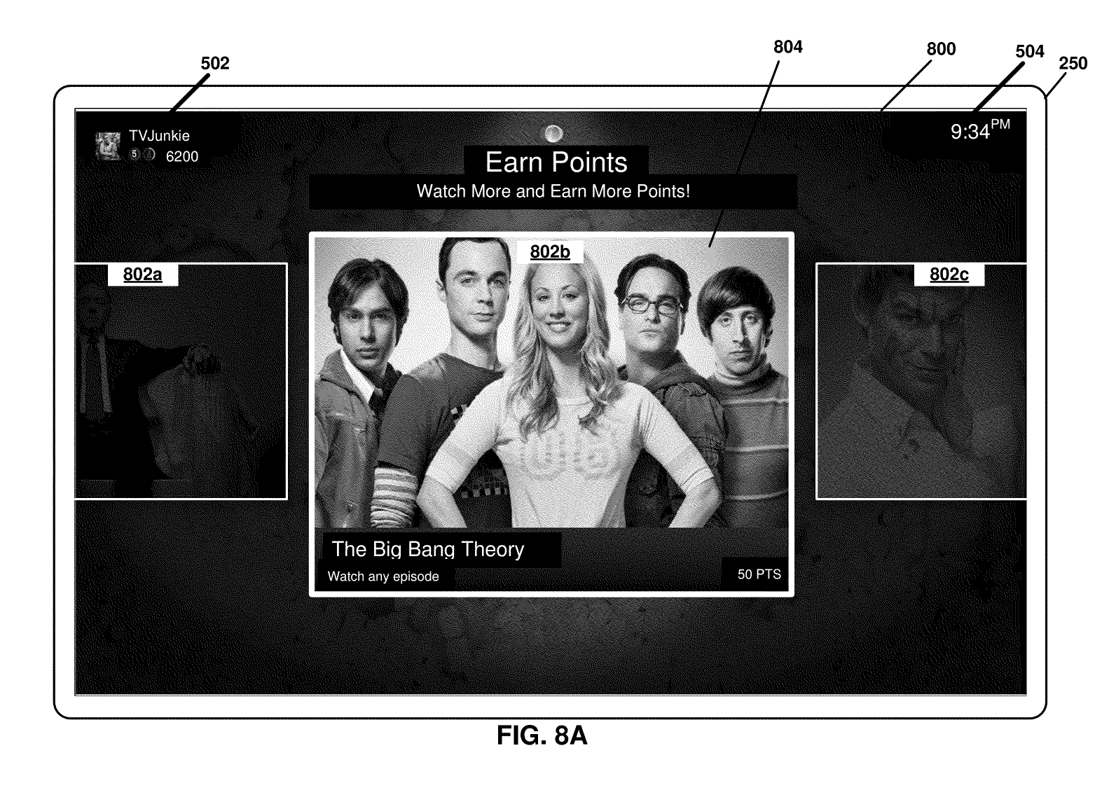

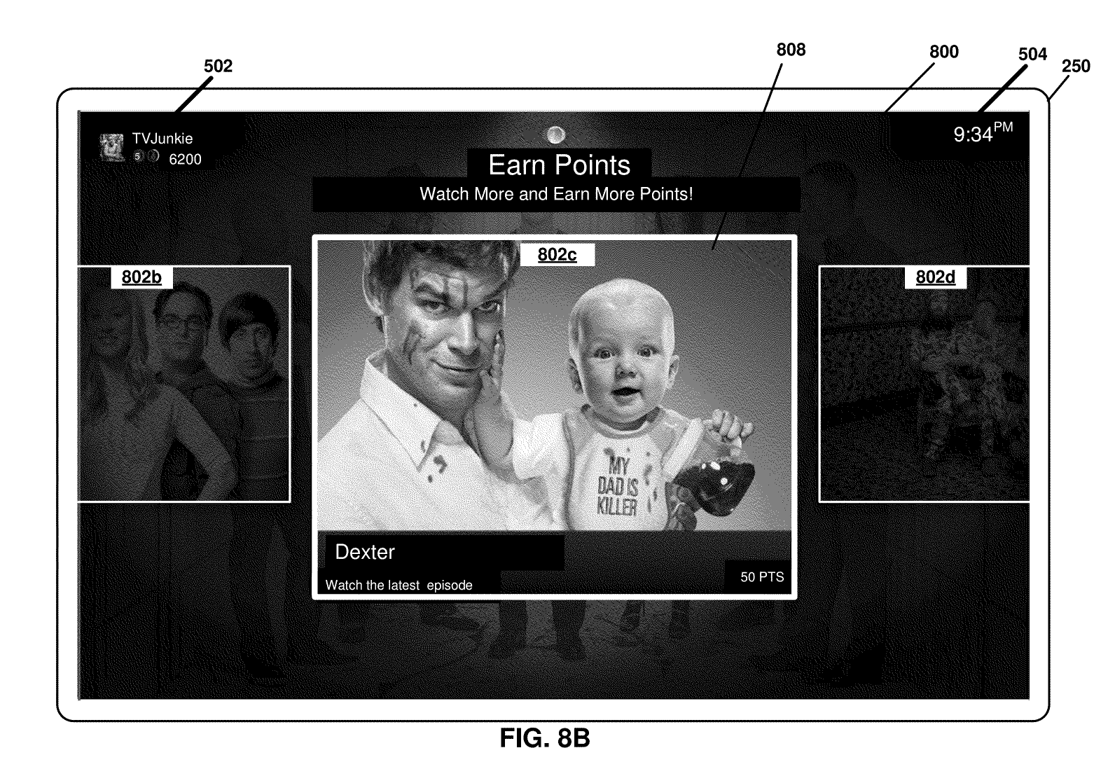

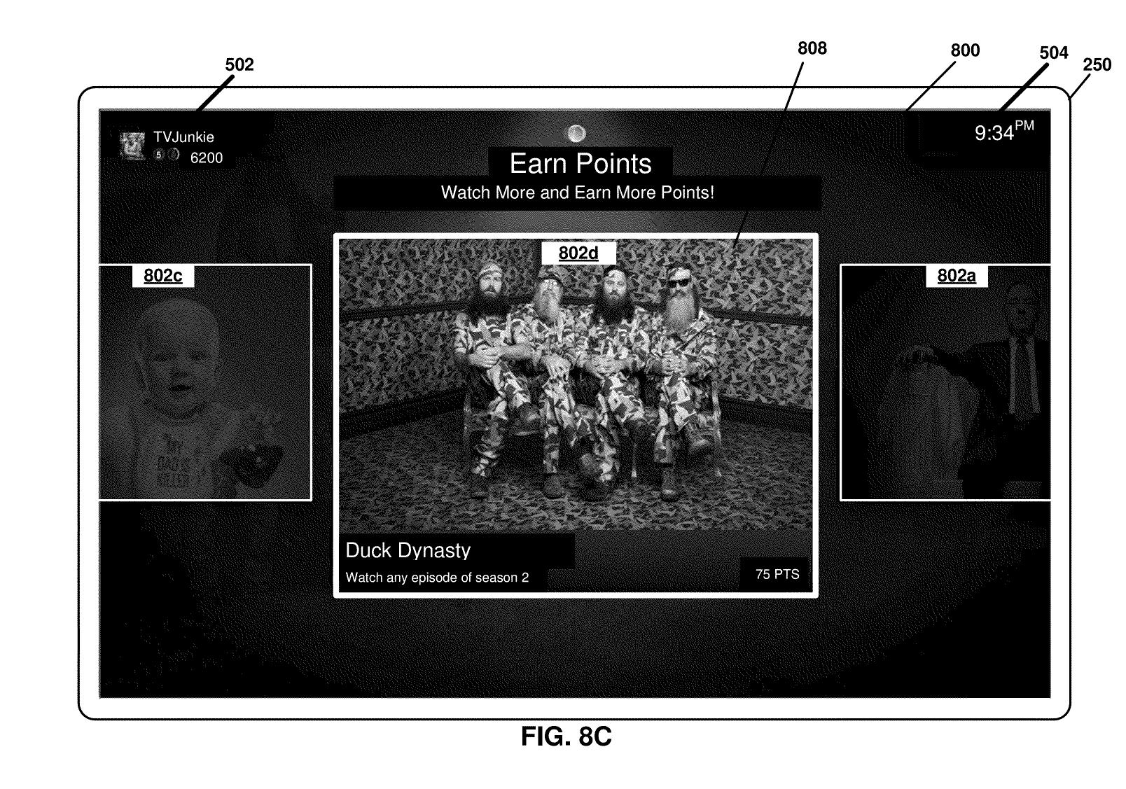

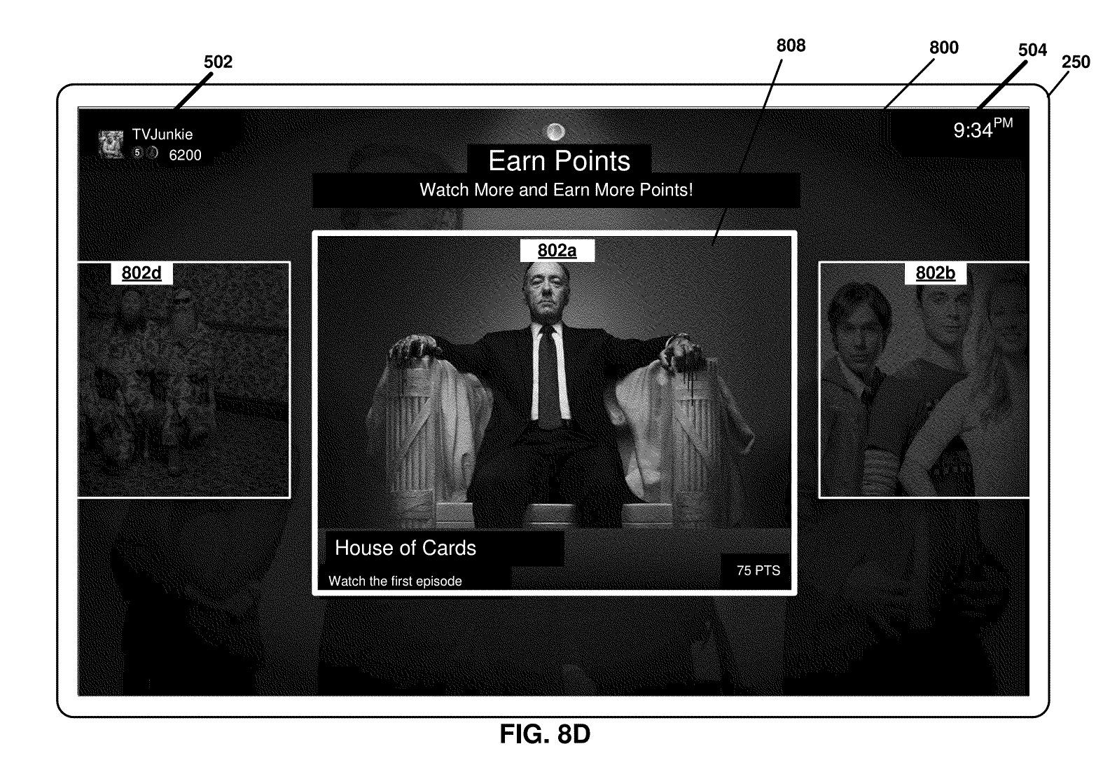

Back button 336 may be configured to enable a user to return to a previous graphical user interface. For example, when graphical user interface 800, described below with respect to FIG. 8 is displayed, activation of back button 336, may cause graphical user interface 700, described below with respect to FIG. 7, to be displayed. Exit button 337 may be configured to enable a user to return to a full screen viewing mode. For example, when a graphical user interface is displayed, upon activation of exit button 337, the graphical user interface may “disappear” and full screen content viewing mode may be presented to a user.

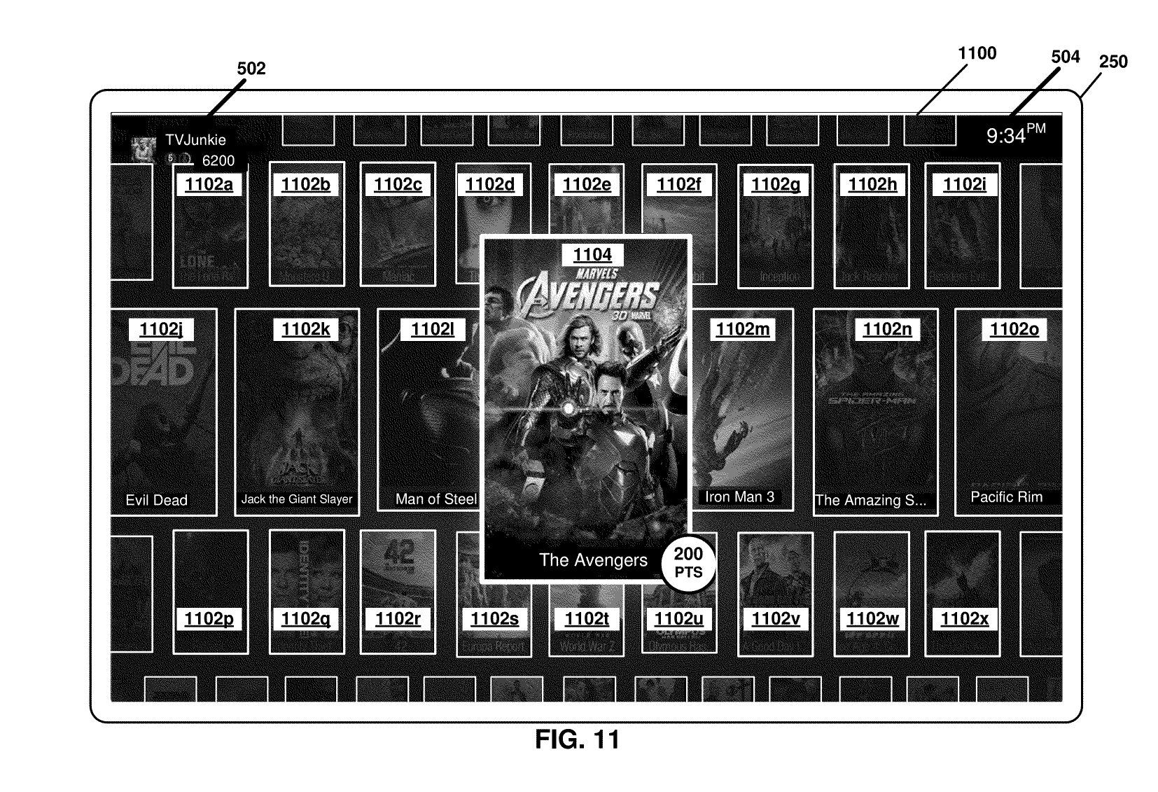

Shortcut controls 340 may be configured to enable a user to cause a particular graphical user interface to be presented regardless of a graphical user interface that is currently presented on a display. In one example, activation of on demand button 342 may cause graphical user interface 1100 described below with respect to FIG. 11 to be presented. In one example, activation of on rewards button 344 may cause graphical user interface 700 described below with respect to FIGS. 7A-7C to be presented.

Referring again to FIG. 2, computing device 200 is configured to send and receive data via a television network, such as, for example, television provider network 106 described above and send and receive data via a public network, such as, for example, public network 108. As described above, a communications network may be described based on a model including layers that define communication properties, such as, for example, physical signaling, addressing, channel access control, packet properties, and data processing in a communications system. In the example illustrated in FIG. 2, modem 212, transport module 214, and AV demux 216 may be configured to perform lower layer processing (e.g., physical layer, link layer, and/or network layer processing) associated with television provider network 106 and network interface 218 may be configured to perform lower layer processing associated with public network 108.

In one example, modem 212 may be configured to perform physical signaling, addressing, and channel access control according to the physical and MAC layers utilized in a television provider network, such as, for example, television provider network 106. In one example, modem 212 may configured to receive signals from a coaxial cable and/or an over the air signal and perform signal processing (e.g., demodulation). In one example, modem 212 may be configured to extract transport streams from signals received from a coaxial cable. In one example, a transport stream may be based on a transport stream defined by the Moving Pictures Experts Group (MPEG). In one example, a transport stream may include a plurality of program streams where each program stream respectively corresponds to a program available from a television network. Further, a transport stream may include a plurality of data streams (e.g., Program Map Table and EPG data).

Transport module 214 may be configured to receive data from modem 212 and process received data. For example, transport model 214 may be configured to receive a transport stream including a plurality of program streams and extract individual program streams. In one example, a program stream may include a video stream, an audio stream, and a data stream. AV demux 216 may be configured to receive data from transport module 214 and process received data. For example, AV demux 216 may be configured to receive a program stream from transport module 214 and extract audio packets, video packets, and data packets. That is, AV demux 216 may apply demultiplexing techniques to separate video streams, audio streams, and data streams from a program stream. In one example, AV demux 216 may be configured to decapsulate packetized elementary video and audio streams from a transport stream defined according to MPEG-2 Part 1. It should be noted that although modem 212, transport module 214, and AV demux 216 are illustrated as having distinct functional blocks, the functions performed by modem 212, transport module 214, and AV demux 216 may be highly integrated and realized using any combination of hardware, firmware and/or software implementations.

Network interface 218 may be configured to enable computing device 200 to send and receive data via a public network, e.g., public network 108. As described above, data sent or received via a public network may include data associated digital content, such as, for example, music, videos, images, webpages, messages, voice communications, and applications. Network interface 218 may include a network interface card, such as an Ethernet card, an optical transceiver, a radio frequency transceiver, or any other type of device configured to send and receive information. Network interface 218 may be configured to perform physical signaling, addressing, and channel access control according to the physical and MAC layers utilized in a public network. Further, in a manner similar to that described above with respect to transport module 214 and A/V demux 216, network interface 218 may be configured to extract audio packets, video packets, and data packets from a data stream. For example, network interface 218 may be configured to extract video packets, audio packets, and data packets according to one or more of internet protocol (IP), transport control protocol (TCP), real time streaming protocol (RTSP), user datagram protocol (UDP), real time protocol (RTP), MPEG transport stream protocols, and IPTV protocols. It should be noted, that the techniques described herein are generally applicable to any and all methods of digital content distribution and are not limited to particular communications network implementations. For example, the techniques described herein may be applicable to digital content originating from one or more of a broadcast, a multicast, a unicast, an over-the-top content source, a personal video recorder (PVR), and a peer-to-peer content source.

Referring again to FIG. 2, data associated with digital content, such as, for example, music, videos, images, webpages, messages, voice communications, and applications may be stored in a computer readable medium, such as, for example, system memory 204 and storage devices 220. Data stored in a memory device may be retrieved and processed by central processing unit(s) 202, audio decoder 224, audio processor 226, video decoder 228, graphics processing unit 230, and display processor 232. As described above, central processing unit(s) 202 may be capable of retrieving and processing instructions, code, and/or data structures for implementing one or more of the techniques described herein. Each of audio decoder 224, audio processor 226, video decoder 228, graphics processing unit 230, and display processor 232 may also be capable of retrieving and processing instructions, code, and/or data structures for implementing one or more of the techniques described herein.

Audio decoder 224 may be configured to retrieve and process coded audio data. For example, audio decoder 224 may be a combination of hardware and software used to implement aspects of audio codec. Audio data may be coded using multi-channel formats such as those developed by Dolby® Laboratories and Digital Theater Systems. Audio data may be coded using a compressed or uncompressed format. Examples of compressed audio formats include MPEG-1, 2 Audio Layers II and III, AC-3, AAC, and Ogg Vorbis. An example of an uncompressed audio format includes pulse-code modulation (PCM) audio format. Audio processor 226 may be configured to retrieve captured audio samples and may process audio data for output to an audio system (not shown). In some examples, audio processor 226 may include a digital to analog converter. An audio system may comprise any of a variety of audio output devices such as headphones, a single-speaker system, a multi-speaker system, or a surround sound system.

Video decoder 228 may be configured to retrieve and process coded video data. For example, video decoder 228 may be a combination of hardware and software used to implement aspects of video codec. In one example, video decoder 228 may be configured to decode video data encode according to any number of video compression standards, such as ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 (also known as ISO/IEC MPEG-4 AVC), VP8, and High-Efficiency Video Coding (HEVC).

As described above, a device with media playback capabilities may provide a graphical user interface that enables a user to select content. A graphical user interface may include images and graphics displayed in conjunction with video content (e.g., playback icons overlaid on a video). Graphics processing unit 230 is an example of a dedicated processing unit that may be configured to generate graphical user interfaces, including the graphical user interfaces described herein. That is, graphics processing unit 230 may be configured to receive commands and content data and output pixel data. Graphic processing unit 230 may operate according to a graphics pipeline process (e.g., input assembler, vertex shader, geometry shader, rasterizer, pixel shader, and output merger). Graphics processing unit 230 may include multiple processing cores and may be configured to operate according to OpenGL (Open Graphic Library, managed by the Khronos Group) and/or Direct3D (managed by Microsoft, Inc.). In one example, graphical processing unit 230 may be configured to display graphical user interfaces illustrated in FIGS. 5-13C.

Display processor 232 may be configured to retrieve and process pixel data for display. For example, display processor 232 may receive pixel data from video decoder 228 and/or graphics processing unit 230 and output data for display. Display processor 232 may be coupled to a display, such as display 250 (not shown in FIG. 1) using a standardized communication protocol (e.g., HDMI, DVI, DisplayPort, component video, composite video, VGA, etc.). Display 250 may comprise one of a variety of display devices such as a liquid crystal display (LCD), a plasma display, an organic light emitting diode (OLED) display, or another type of display device capable of presenting video data to a user. Display 250 may include a standard definition television, a high definition television or an ultra-resolution display. Further, display 250 may include an integrated display of a portable computing device (e.g., a mobile phone, a laptop, a personal data assistant (PDA), tablet device, etc.). As described above, in some examples a portable computing device may operate as an I/O device for a stationary computing device.

As described above, traditional electronic program guides (EPGs) may be less than ideal for enabling a user to earn and redeem points. Further, traditional electronic programming guides may be less than ideal for enabling a user to browse and access on demand content. Computing device 200 may be configured to enable a user to earn and redeem points by providing one or more of the graphical user interfaces described herein. In one example, a user may earn points by accessing particular items of content. The graphical user interfaces described herein may be provided to a computing device and/or an I/O device in communication with a computing device, e.g., a companion device. FIGS. 5-13C are conceptual diagrams illustrating examples of graphical user interfaces that may be generated by a computing device in accordance with one or more techniques of this disclosure.

FIG. 4 is a conceptual diagram illustrating example navigational paths to example graphical user interfaces in accordance with one or more techniques of this disclosure. Example navigational diagram 400 illustrates examples of commands (e.g., button activations, voice commands, touch screen area activations, automated commands, etc.) that may cause particular graphical user interfaces to be presented. It should be noted that although graphical user interfaces described with respect to example navigational diagram 400 are described in a particular sequence, such a sequence is for illustrative purposes and should not be construed to limit how graphical user interfaces may be presented. As illustrated in FIG. 4, upon activation of a menu command, in one example, graphical user interface 500 may be presented and in one example, graphical user interface 600 may be presented. In one example, activation of a menu command may include a user activating menu button 334. Each of graphical user interface 500 and graphical user interface 600 may provide an interface enabling a user to launch a rewards application.

Referring to FIG. 5, graphical user interface 500 is an example of a graphical user interface that enables a user to view and select particular types of items of content. In the example illustrated in FIG. 5, graphical user interface 500 includes user profile identifier 502, time indicator 504, which provides the current time, games stack structure 506, travel related application stack structure 508, utility related application stack structure 510, music related application stack structure 512, and photo related application stack structure 514. Example graphical user interfaces including stack structures are described in commonly-assigned currently pending U.S. patent application Ser. No. 14/336,758, filed Jul. 21, 2014, which is incorporated by reference in its entirety. In the example illustrated in FIG. 5, user profile identifier 502 identifies the profile of the user that is currently operating computing device 200 (i.e., currently logged-in, or the like). In the example illustrated in FIG. 5, a user identified as “TVJunkie” is currently logged-in. As further illustrated in FIG. 5, user profile identifier 502 includes points earned by a user (e.g., 6200), a level associated with a user (e.g., 5), and trophies associated with a user. Each of points earned by a user, a level associated with a user, and trophies associated with a user are described in greater detail below.

In the example illustrated in FIG. 5, utility related application stack structure 510 is the currently selected stack structure, i.e., available for additional selection. In one example, a user may cause one of games stack structure 506, travel related application stack structure 508, music related application stack structure 512, or photo related application stack structure 514 to become selected through subsequent activations of left and right arrows of navigational arrow buttons 331 or the like. As illustrated in FIG. 5, utility related application stack structure 510 includes icon representing a rewards application 516. A user may be able to select the icon representing a rewards application, thereby launching a rewards application. In one example, a user may activate select button 332 to cause utility related application stack structure 510 to be further selected and thereby enable the selection of icon representing a rewards application 516.

Referring to FIG. 6, graphical user interface 600 illustrates another graphical user interface from which a rewards application may be launched. As illustrated in FIG. 6, graphical user interface 600 includes a plurality of panes 602a-602h where each pane represents multimedia content or an application. Further, graphical user interface 600 includes a selected pane displaying video content 604. An example of a pane based graphical user interface is described in commonly-assigned currently pending U.S. patent application Ser. No. 14/480,990, filed Sep. 9, 2014, which is incorporated by reference in its entirety. In one example, a user may cause one or more of panes 602a-602h to become selected through subsequent activations of navigational arrow buttons 331. Upon initial or an additional selection (e.g., activation of select button 332) an associated application may be launched. In the example illustrated in FIG. 6, graphical user interface 600 includes time and date pane 602a, user identifier pane 602b, weather pane 602c, rewards application pane 602d, ambiance setting pane 602e, streaming music pane 602f, home thermostat control pane 602g, and music pane 602h. In a similar manner to icon representing a rewards application 516, described above, selection of rewards application pane 602d may cause a rewards application to be launched. Further, referring to FIG. 4, in one example, activation of a rewards command (e.g., a user activating rewards button 344) may cause a rewards application to be launched.

FIGS. 7A-7C are conceptual diagrams illustrating an example of a graphical user interface in accordance with one or more techniques of this disclosure. Graphical user interface 700 represents an example of a graphical user interface that may be displayed when a rewards application is launched. As illustrated in FIGS. 7A-7C, graphical user interface 700 includes a respective cards (which may be referred to as panes in some examples) associated with a user profile (i.e., profile card 702 illustrated as centered in FIG. 7A), a card associated with point earning opportunities (earn points card 706 illustrated as centered in FIG. 7B), and a card associated with redeeming points (redeem card 704 illustrated as centered in FIG. 7C). As illustrated in FIGS. 7A-7C, one of profile card 702, redeem card 704, or earn points card 706 may be a selected card 708. Further, as illustrated in FIGS. 7B-7C, in some examples, graphical user interface 700 may present user profile identifier 502 and time indicator 504.

A user may cycle through profile card 702, redeem card 704, and earn points card 706 using left/right scrolling commands (e.g., using navigational arrow keys on a remote control, using motion gestures, performing swipe gestures on a touchscreen, etc.). As illustrated in FIG. 7A, profile card 702 includes identifying information associated with a user (e.g., a screen name, an image, and a description of interests). Further, as illustrated in FIG. 7A profile card 702 includes a summary of a user's activity, e.g., level, medals, and points. As described in detail below, points may be earned by accessing content including televisions shows, movies, advertisements, and the like. In one example, points may be proportioned according with a level of user interactivity. For example, simply viewing a commercial may earn a user 10 points and watching a commercial and completing a survey may earn a user 20 points. In one example, levels may be based on particular point thresholds. For example, a level 1 status may be designated if a user has accumulated under 1000 points and a level 2 status may be designated once a user has accumulated more than 1000 points. In one example, levels and/or points may be associated with ability to access content. For example, users having a level 4 status and above may be able to access exclusive content from a television service provider or from a media service provider. Exclusive content may include, for example, sneak previews, exclusive trailers, earlier releases, bonus content (e.g., outtakes, production/behind the scenes documentaries, and cast and crew member interviews), and/or interactive applications associated with multimedia content. Further, points may be redeemed for items and services. In one example, medals may be based on a user accessing particular types of content. For example, a user may receive a medal for watching a particular number of movies included in a category (e.g., a romantic comedy category medal). As further illustrated in FIG. 7A, profile card 702 may include links to one or more of television viewing history, movie viewing history, and event history (e.g., a log of applications launched, etc.).

As illustrated in FIG. 7B, redeem card 704 includes featured rewards. Featured rewards may be a subset of available rewards. Featured rewards may be selected based on any and all combinations of consumption, behavior, and environment. In one example, consumption may include content a user has accessed or is accessing. In one example, behavior may include user usage information such as, for example, how fast the user changes channels, how often the user skips commercials, how frequently a user accesses content through a computing device. In one example, environment may include time (e.g., hour, day, month, or year) and location (e.g., home, car, or airport) of a computing device. Further, featured rewards may be selected based on the number of points a user has earns, a level a user has obtained, and/or medals a user as earned. As illustrated in FIG. 7C, earn points card 704 includes featured items of content. Featured items of content may be a subset of available items of content. Featured items of content may be selected based on any and all combinations of consumption, behavior, and environment.

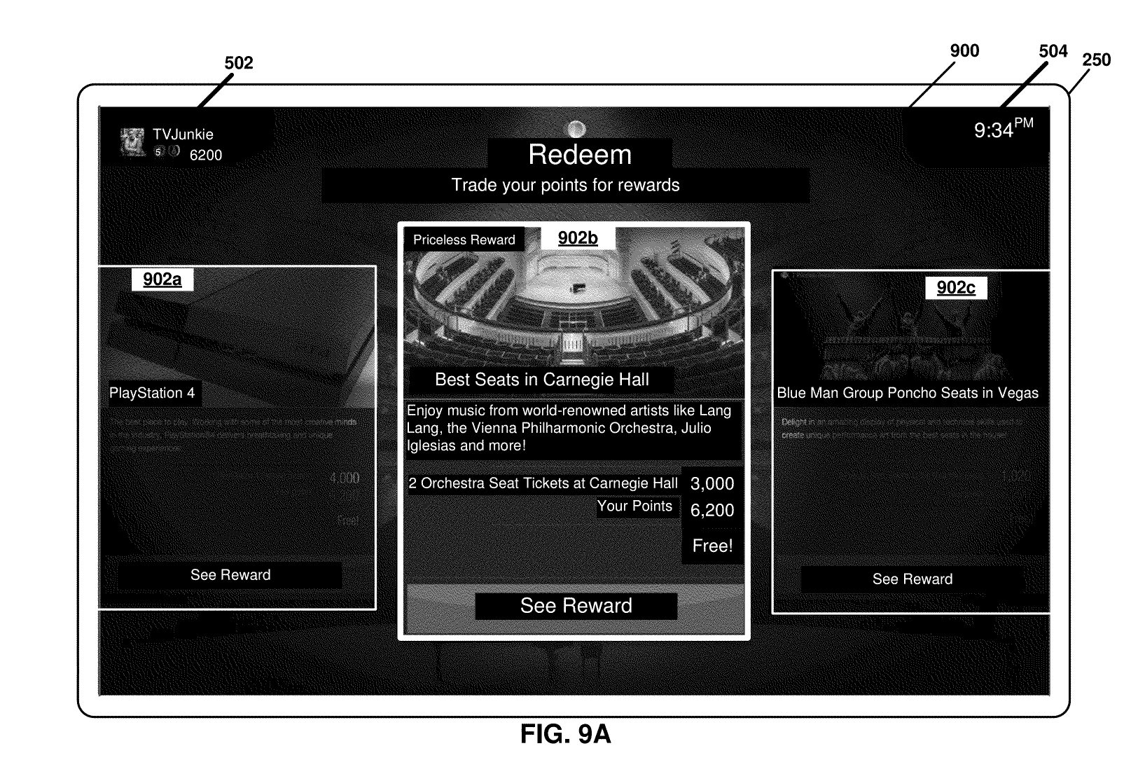

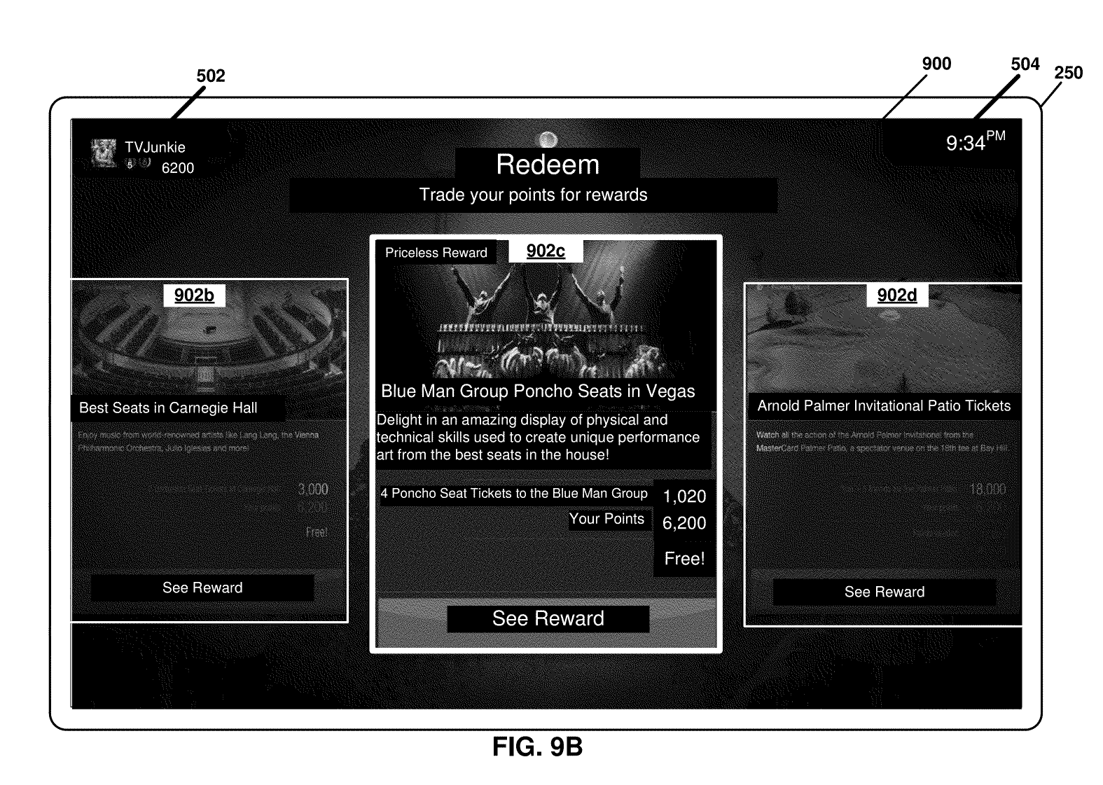

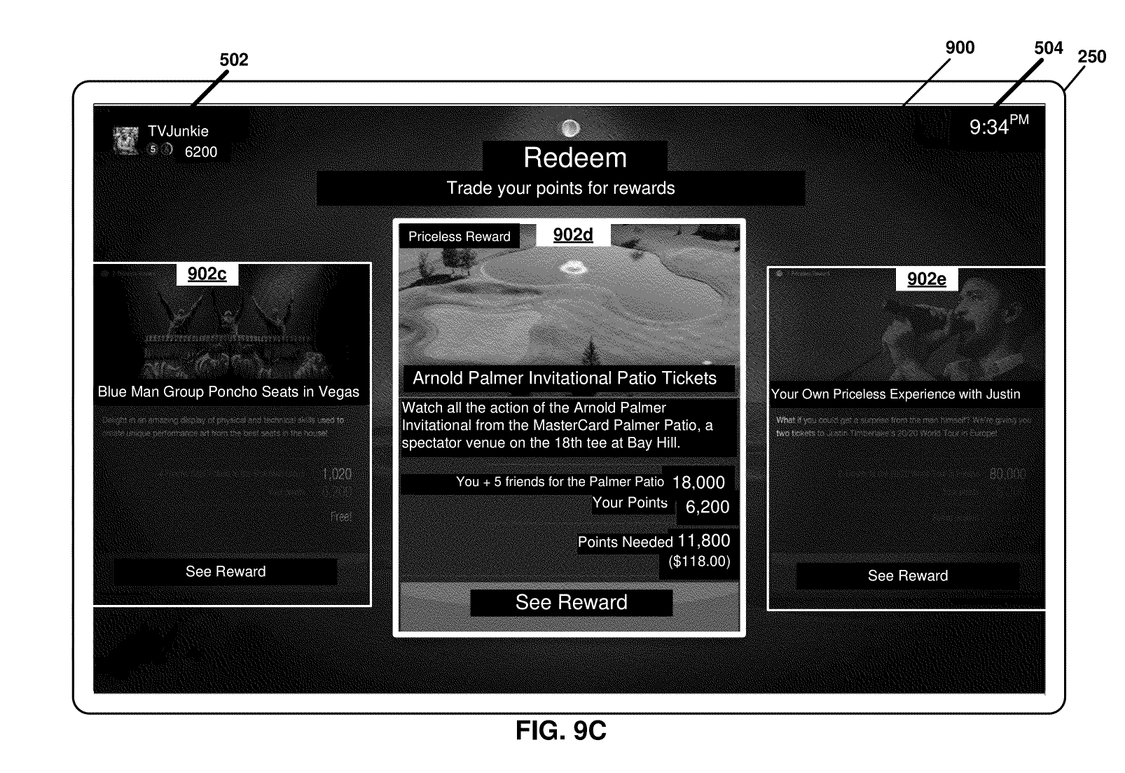

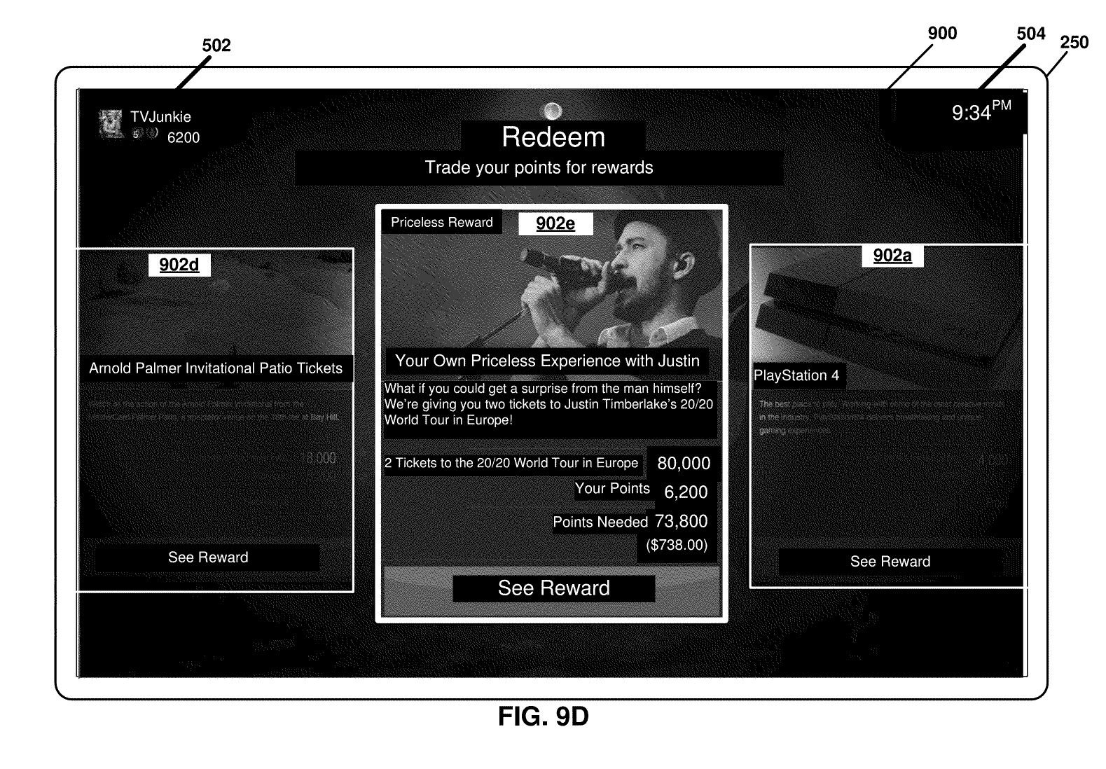

When one of profile card 702, redeem card 704, or earn points card 706 is centered in graphical user interface 700, it and/or items represented thereon may be available for additional selection. An example of a graphical user interface that may be presented when earn points card 706 is selected is described with respect to FIGS. 8A-8D. An example of a graphical user interface that may be presented when redeem card 704 is selected is described with respect to FIGS. 9A-9D. As illustrated FIGS. 8A-8D and FIGS. 9A-9D, the card structure of the graphical user interfaces illustrated in FIGS. 7A-7C is preserved. That is, cards associated with point earning opportunities may be cycled through and cards associated with rewards may be cycled through in a manner similar to profile card 702, redeem card 704, and earn points card 706. Further, each of the graphical user interfaces illustrated in FIGS. 8A-8D and FIGS. 9A-9D may present user profile identifier 502 and time indicator 504.

In one example, when a user wishes to earn points a user may select earn points card 706 which may cause graphical user interface 800 to be presented. It should be noted in other examples, a user may say “earn points” or the like to cause graphical user interface 800 to be presented. In the example illustrated in FIGS. 8A-8D, graphical user interface 800 includes items of content, in this case television shows, associated with point earning opportunities. That is, if a user accesses an item of content represented as a card in graphical user interface 800, the user may earn the associated number of points. In the example illustrated in FIGS. 8A-8D, cards include cards 802a-802d. It should be noted that in other examples fewer or more cards, including cards associated with other types of content (e.g., movies, music videos, etc.) may be presented. Each of cards 802a-802d include a visual identifier associated with the item of content, a title associated with the item of content, a required activity for earning points, and a point value associated with the earning opportunity. A television provider and/or a multimedia provider may define point earning opportunities based on one or more of particular user habits (e.g., a provider may define a point earning opportunity based on content a user has accessed in the past), and/or a promotion from a content provider or a content producer (e.g., a content producer may provide a point earning opportunity for accessing past episodes of a television series in order to increase the likelihood that a user will watch a current season of a television program). As illustrated in FIGS. 8A-8D, the number of points and which of the episodes of a series may be watched in order to earn the number of points may be displayed on a card (e.g., watch any episode of season 2 to earn 75 points). After a user has earned a sufficient amount of points a user may wish to redeem earned points for a reward.

In one example, when a user wishes to redeem points a user may select redeem points card 704 which may cause graphical user interface 900 to be presented. It should be noted in other examples, a user may say “redeem” or the like to cause graphical user interface 900 to be presented. As illustrated in FIG. 9A-9D, graphical user interface 900 preserves the card structure described above and each card 902a-902e associated with a reward may be cycled through be a user using left/right scrolling commands. It should be noted that in other examples fewer or more cards associated with rewards may be presented. As illustrated in FIGS. 9A-9D, each of the cards 902a-902e include an image/video associated with a reward, a description of the reward, a number of reward points associated with the reward, the total number of points available to a user, and a resulting number of points or dollar amount required to purchase/access the reward. In this manner, graphical user interface 900 provides an efficient way for a user to determine if a user can redeem a reward with existing earned points or if additional points or a currency amount are needed to redeem a reward. Further, each of the cards 902a-902e include an icon (i.e., “See Reward”), that upon activation presents a graphical user interface that enables a user to see more detailed information about the reward and/or purchase/access the reward.

It should be noted that in FIGS. 9A-9D, some of the rewards are standard rewards (e.g., PlayStation 4 reward) and some of the rewards are sponsored rewards (e.g., Best Seats in Carnegie Hall reward). In the example illustrated in FIGS. 9A-9D, sponsored rewards are indicated at “Priceless Rewards.” In one example, a sponsored reward may refer to a reward that a financial institution (or another business other than a service provider) promotes in order to create a new customer (e.g., a cable television subscriber that currently does not have any accounts with the financial institution), create additional transactions from an existing customer (e.g., cause a user to charge a purchase associated with reward to a credit card), or the like. In this manner, a television provider or media service provider and a financial institution may participate in a joint marketing campaign. Thus, graphical user interface 900 may facilitate the creation of joint marketing campaigns by providing an unobtrusive way for sponsored rewards to be presented to a user. After browsing through available rewards using graphical user interface 900, a user may wish to receive more information about a reward and/or redeem a reward.

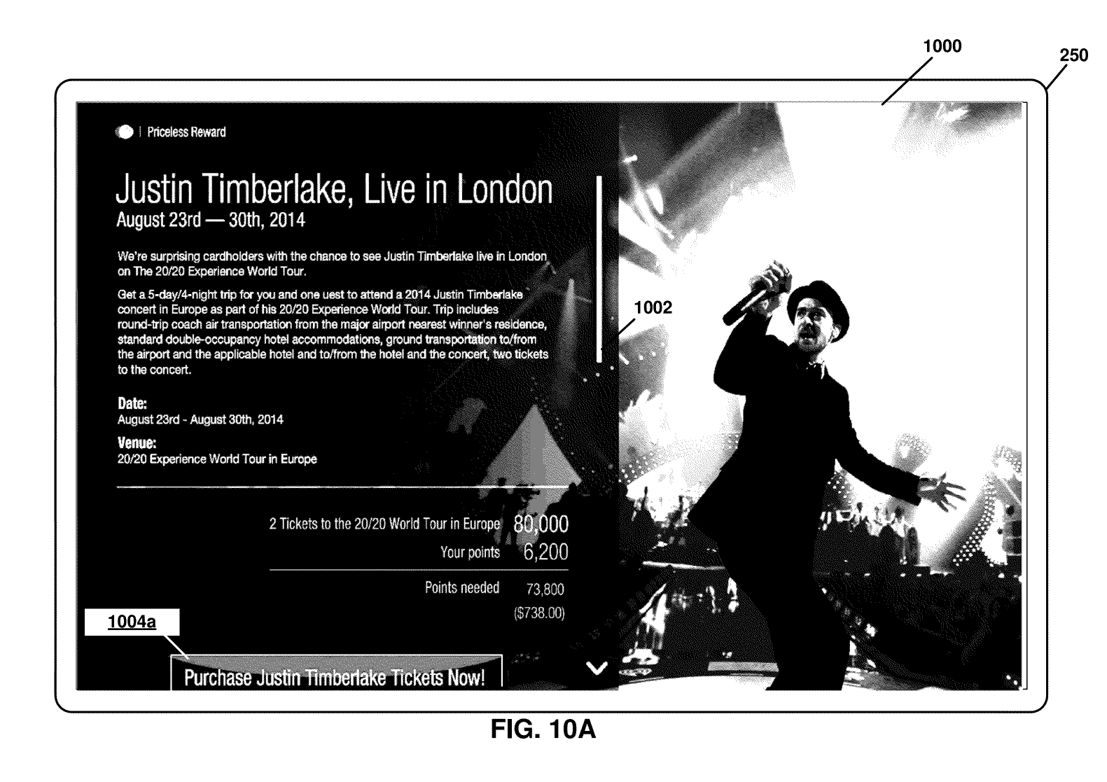

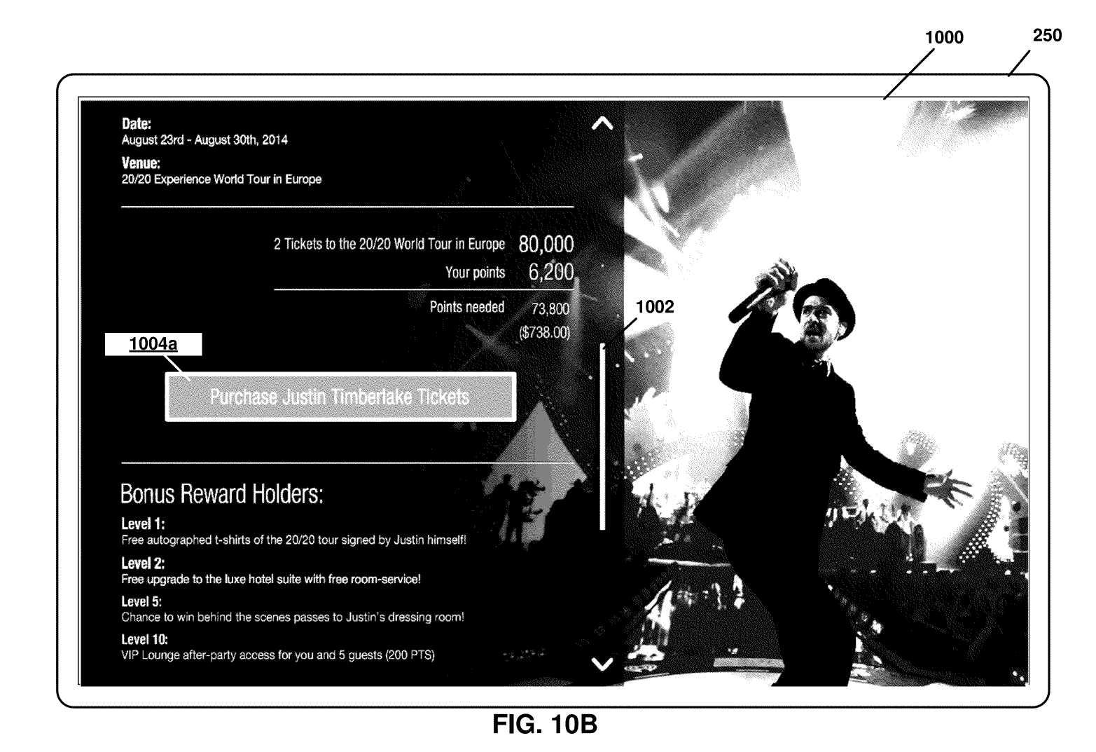

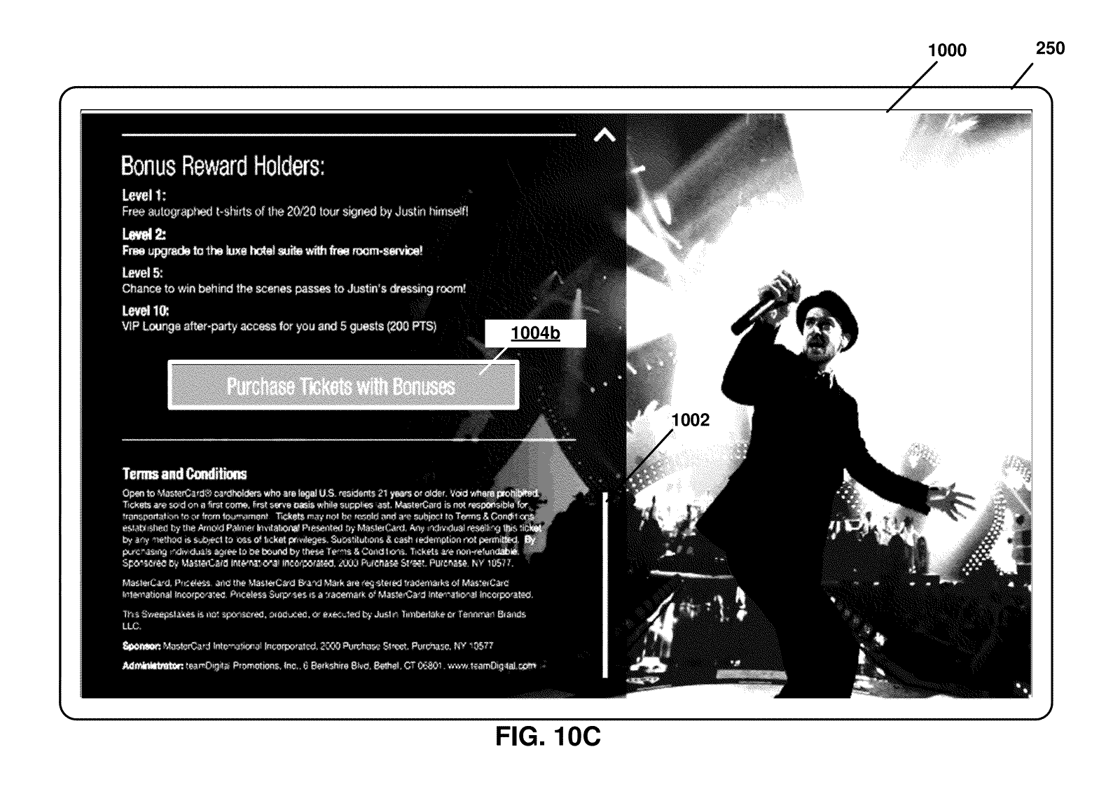

FIGS. 10A-10C is an example of a graphical user interface that may be displayed when a reward card is additionally selected (e.g., reward card 902e). As illustrated in FIGS. 10A-10C, a graphical user interface associated with a reward may include a detailed description of the reward, points required for the reward, a user's points, and resulting points or a dollar amount needed to purchase a reward. Further, a user may scroll down to select/view icon 1004a which provides a user an option to purchase a reward and may further scroll down to select/view icon 1004b which provides a user an option to purchase a reward with bonuses. As illustrated in FIGS. 10B-10C bonuses may be associated with levels and/or medals obtained by a user. That is, bonuses may be available if a user has obtained a certain level status and/or medal. In one example, levels and/or medals enabling bonus options may correspond to levels and medals described above with respect to FIGS. 7A-7C.

Referring again to FIG. 4, activation of an on demand command may cause graphical user interface 1100 to be presented. In one example, activation on an on demand command may include activation of on demand button 342. In one example, graphical user interface 1100 may be presented to a user upon a user selecting an On Demand option from a menu and/or a user selecting a stack associated with on demand content. As described in detail below, accessing on demand content through the example graphic user interfaces illustrated in FIGS. 11-13C may enable a user to earn points. As further described in detail below, in some examples, a user may redeem points to access on demand content. It should be noted that the graphical user interfaces illustrated in FIGS. 11-13C may be generally applicable to enabling a user to browse and access on demand content. That is, the graphical user interface illustrated in FIGS. 11-13C may be implemented in a media service that does not support reward points.

Referring to FIG. 11, graphical user interface 1100 displays items of content and any associated point earning opportunities. Further, graphical user interface 1100 displays user profile identifier 502 and time indicator 504. In the example illustrated in FIG. 11, graphical user interface 1100 enables a user to browse movies that are available to access on an on demand basis. In other examples, other types of items of content (e.g., television shows, etc.) may be included in graphical user interface 1100. As illustrated in FIG. 11, for each of available items of content 1102a-1102x an image (also referred to as box-shot) associated with the movie is displayed. Further, graphical user interface 1100 includes a selected item of content (i.e., Avengers) which is presented in the “foreground” of graphical user interface 1100. In the example, illustrated in FIG. 11, the number of points (i.e., 200) associated with accessing Avengers, the selected item of content, is displayed in the bottom right of box-shot. A user may cause other of items of content 1102a-1102x to become the selected item of content using navigational arrow keys on a remote control (e.g., navigational arrows 331), using motion gestures, performing swipe gestures on a touchscreen, or the like.

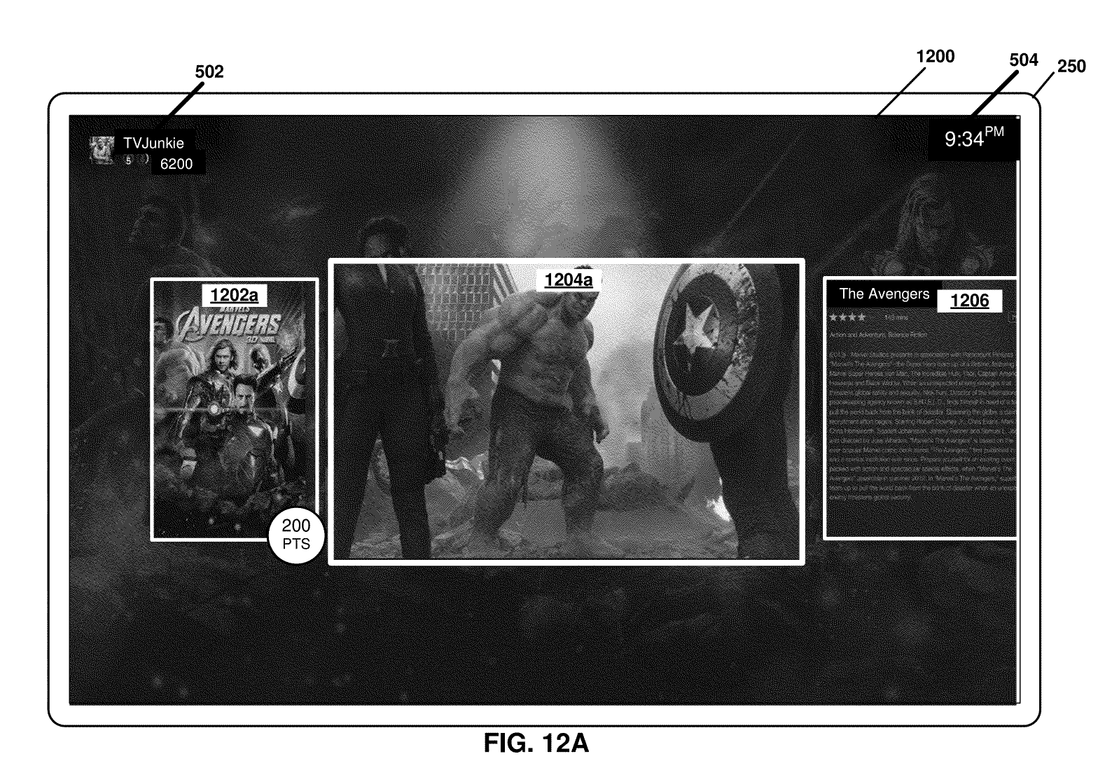

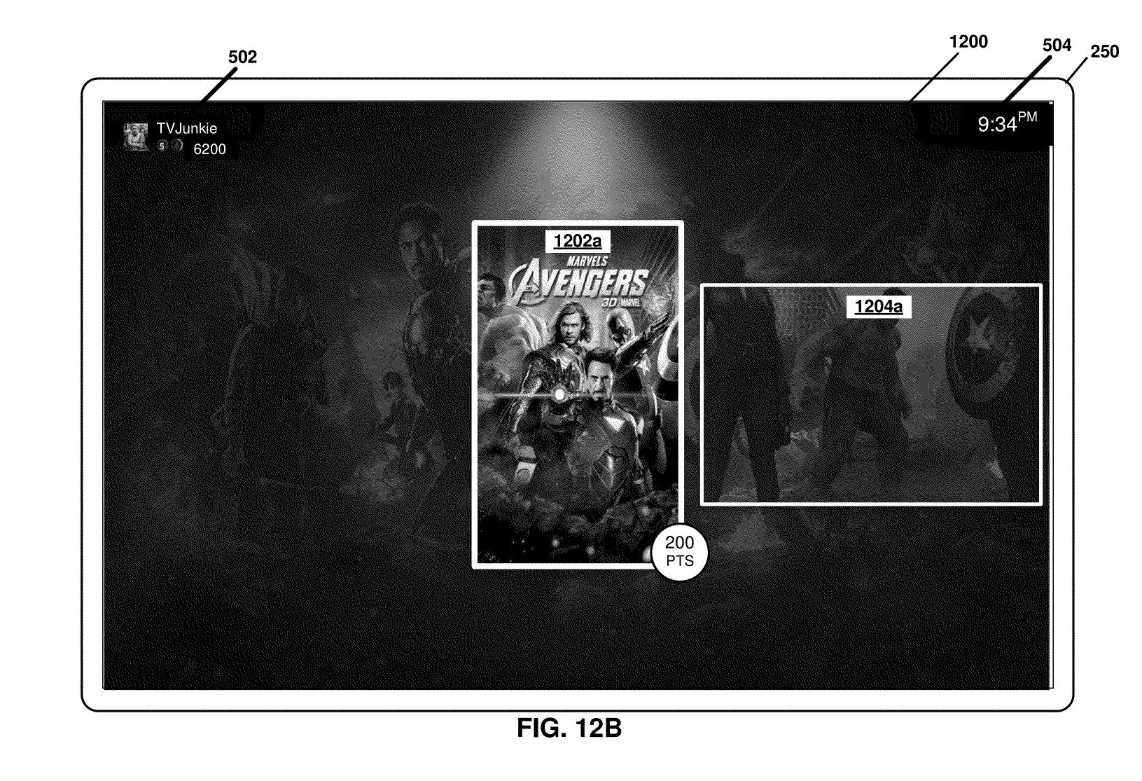

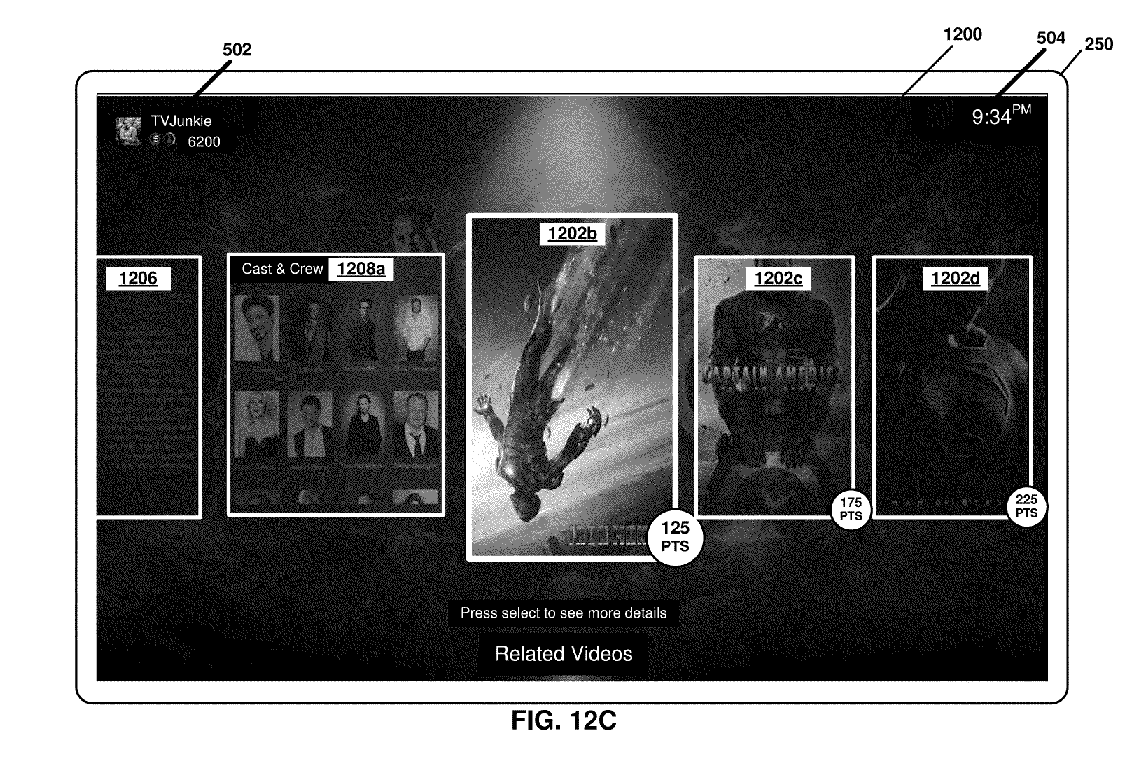

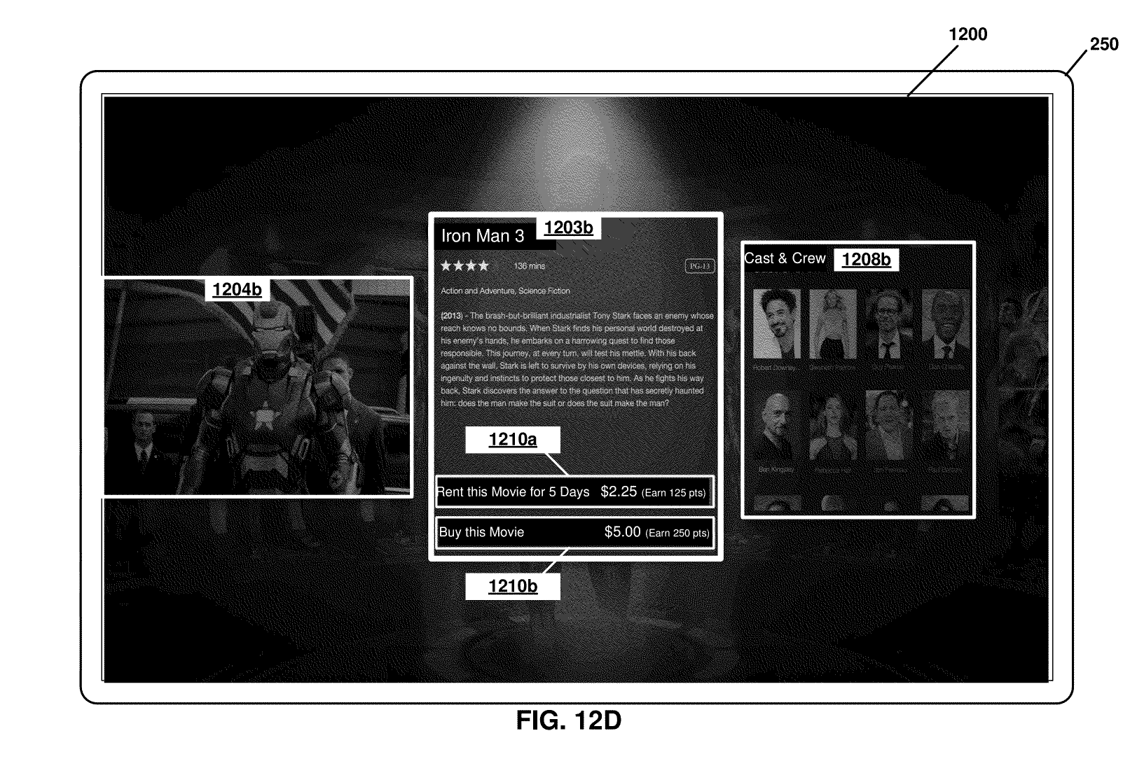

A user may additional select the Avengers, or another selected item of content, using a select, enter, or more information command, e.g., activating the information button 333 on a remote control 300. Upon additionally selecting an item of content from graphical user interface 1100, the graphical user interface illustrated in FIGS. 12A-12C may be displayed. As illustrated in FIGS. 12A-12C, the card navigation structure described above with respect to FIGS. 7A-9D is preserved. That is, cards associated with the item of content, including cards associated with related items of content may be cycled/scrolled through. In the example illustrated in FIGS. 12A-12C, graphical user interface 1200 includes box shot cards 1202a-1202d, media cards 1204a-1204b, informational cards 1206a-1206b, and cast and crew cards 1208a-1208b.

In the example illustrated in FIG. 12A, upon a user selecting Avengers from graphical user interface 1100, media card 1204a is featured (i.e., centered and highlighted) in graphical user interface 1200. A media card may include a video preview or an image associated with the item of content. As further illustrated in FIG. 12A, upon a user selecting Avengers from graphical user interface 1100, box shot card 1202a associated with Avengers and information card 1206a associated with Avengers are presented in graphical user interface 1200. In this manner, upon the selection of an item of content from graphical user interface 1100 a user may be presented with sufficient information to determine if the user wishes to further access the item of content. A user may case cards other than media card 1204a to be featured by activating respective scroll left and right commands. FIG. 12B illustrates an example where a user activates a scroll left command when media card 1204a is featured, as illustrated in FIG. 12A. As illustrated in FIG. 12B box shot card 1202a becomes featured.

FIG. 12C illustrates an example where a user activates two consecutive scroll right commands when media card 1204a is featured. Referring to FIG. 12C, when a user activates the consecutive scroll right commands, related items of content are displayed. That is, box shot cards 1202b-1202d are displayed within graphical user interface 1200. In the example illustrated in FIG. 12C points that may be earned for viewing each of the related items of related are respectively displayed at bottom right of the box-shot cards 1202b-1202d. In the example illustrated in FIG. 12C, box shot card 1202b (Iron Man 3) is the featured box shot card. A user may additionally select an item of content associated with a featured card.

FIG. 12D is an example of a graphical user interface that may be displayed when an item of content 1202b illustrated in FIG. 12C is additionally selected. Comparing FIG. 12C to FIG. 12D, the additional selection of box shot card 1202b causes media card 1204b and cast and crew card 1208b, each of which are associated with Iron Man 3, to be presented. Further, in the graphical user interface illustrated in FIG. 12D, information card 1203b including an option to access (e.g., buy or rent) the item of content is featured. In one example, box shot card 1202b may visually “flip-over” to transition into information card 1203b. Such visual transitions may create a better experience for a user. That is, the simulation of physical cards that can be flipped over may provide a more engaging user experience that may ultimately cause a user to access on demand content more frequently and as such service provider revenue may be increased.

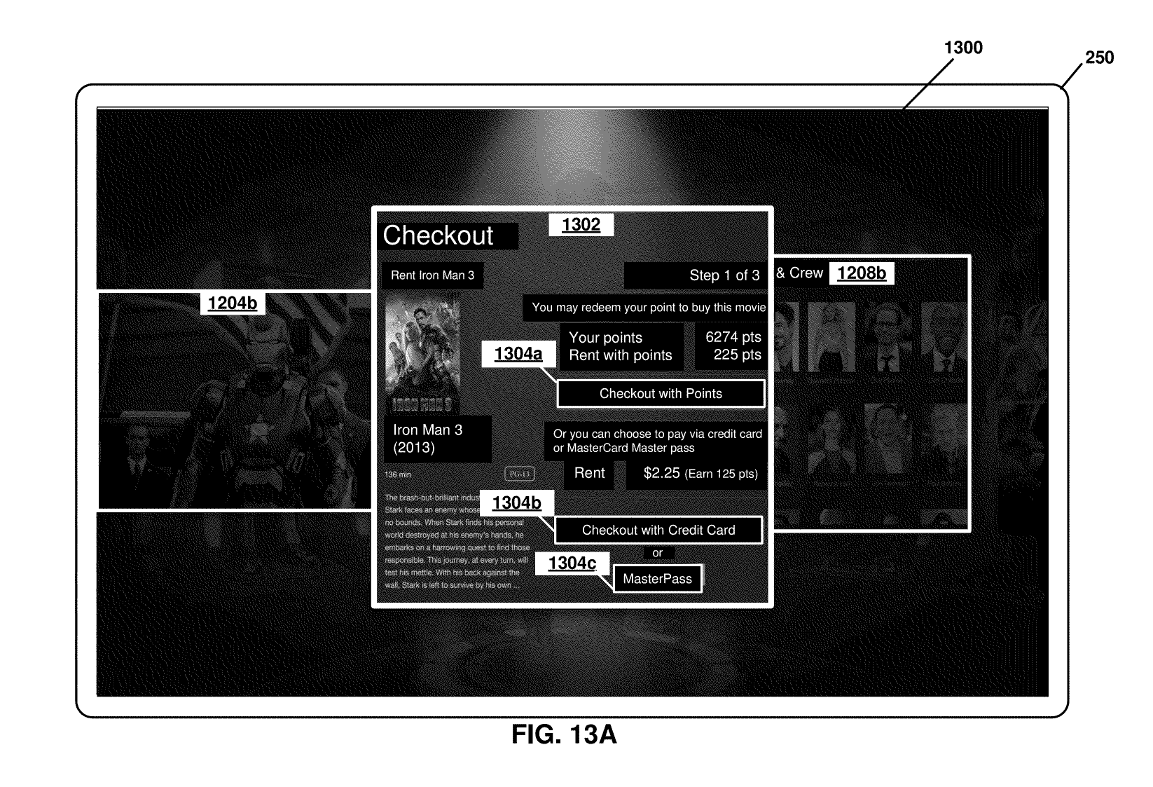

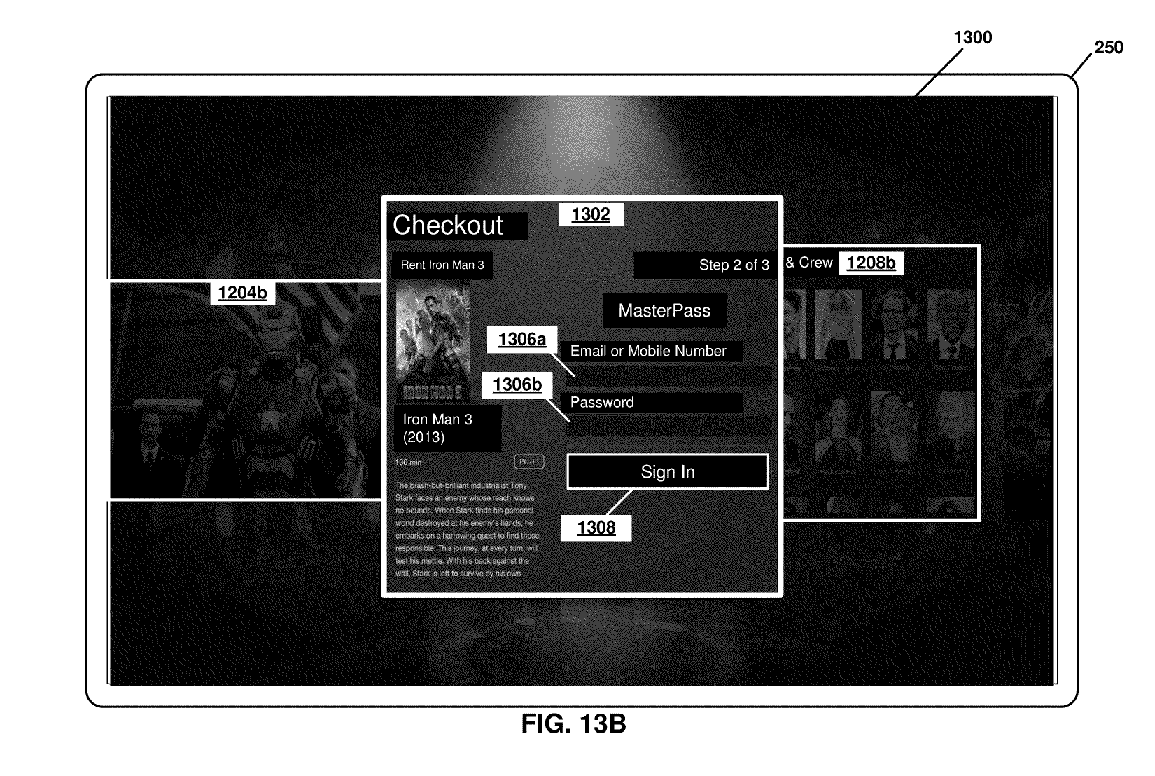

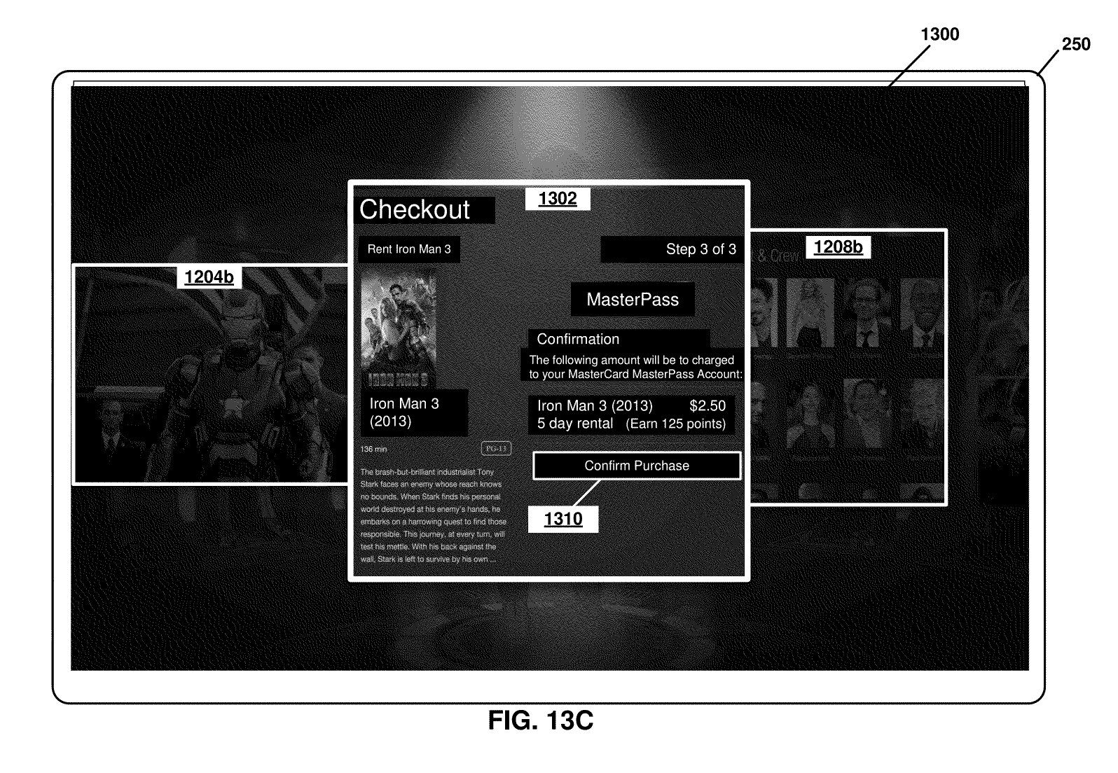

As illustrated in FIG. 12D, information card 1203b includes icon 1210a and icon 1210b. In the example illustrated in FIG. 12D each of icons 1210a and 1210b correspond to access options. Each of icon 1210a and icon 1210b include an access option (e.g., Rent this Movie for 5 Days or Buy this Movie), a price associated with an access option (e.g., $2.25 or $5.00), and an amount of points that will be earning if the user selects the access option (e.g., 125 or 250). A user may cause one of respective icons 1210a or 1210b to be highlighted using navigation controls 331 or the like. Upon a user additionally selecting a highlighted icon, graphical user interface 1300 illustrated in FIGS. 13A-13C may be presented. In one example, information card 1203b may “flip-over” to present the checkout card 1302 illustrated in FIG. 13A. FIG. 4, illustrates an example navigational transition from graphical user interface 1200 to graphical user interface 1300.

In the example illustrated in FIGS. 13A-13C, the example checkout process includes three steps. It should be noted that in other examples, the checkout process may include fewer or more steps based on a purchase option that is selected. Further, the number of steps in a checkout process may be based one or more user preferences. For example, a user may wish to credit an account with a service provider so that a check out process requires fewer steps. In the example illustrated in FIGS. 13A-13C, checkout card 1302 enables a user to “purchase” content using one of three options (1) option to purchase with points, (2) the option to purchase with a credit card, or (3) the option to purchase with an expedited payment system (e.g., MasterPass or the like). An expedited payment system may include a payment system that has some level of pre-authorization. For example, a multimedia provider or television service provider may store information associated with a user's preferred credit card enabling a more efficient authorization process to occur. It should be noted in other examples an expedited payment system may include a so-call mobile payment or digital wallet service.

As illustrated in FIG. 13A, check out card 1302 includes icons 1304a-1304c wherein each of icons 1304a-1304c is associated with a respective purchase option. Icons 1304a-1304c may be selected in a manner to icons 1212a-1212b. As further illustrated in FIG. 13A, checkout card 1302 includes a user's available points (i.e., 6274), the number of points required to be redeemed to access the content (i.e., 225), the dollar amount required to access the content (i.e., $2.25), and number of points that may be earned if a user accesses the content (i.e., 125). Upon a user selecting one of icons 1304a-1304c, check out card 1302 may present additional information that enables user to complete a check our process.

FIGS. 13B-13C illustrate an example of an expedited payment checkout process. FIG. 13B illustrates an example where check out card 1302 enables a user to login to an expedited payment account. In the example illustrated in FIG. 13B, check card 1302 includes identifier field 1306a and password field 1306b. As illustrated in FIG. 13B, a user may enter an email or mobile phone number into field 1306a and a corresponding password 1306b. Upon entering an identifier and a password, a user may select sign in icon 1308 which may cause a user's credentials to be verified. Upon a user's credentials being verified, a checkout card 1302 may include information that enable a user to confirm a purchase. It should be noted in some examples, a confirmation step may be optional. FIG. 13C illustrates an example where a checkout card 1302 includes information enabling a user to complete/confirm a purchase using the expedited payment process. In the example illustrated in FIG. 13C, checkout card 1302 includes purchase information (e.g., a charge amount, points earned, and access condition) and confirmation icon 1310. A user may select confirmation icon 1310 to confirm a purchase. Upon a user confirming a purchase, the purchase item of content may begin to be displayed, added to a library or queue of item of contents that user may access, or the like.

It should be noted that a computing device may display any and all combinations of the graphical user interfaces illustrated in FIGS. 5A-12C and the example descriptions of how graphical user interfaces may be presented to a user are for illustrative purposes. For example, a computing device may be configured to present a subset of the graphical user interfaces described herein using navigational techniques paths other than the example navigation techniques described above. In this manner, computing device 200 represents an example of a device configured present graphical user interfaces enabling a user to earn and redeem rewards. In this manner, computing device 200 represents an example of a computing device that may be configured to display a graphical user interface that enables a user purchase access to an item of content using a combination of earned points and a currency and further earn points.

As described herein, in one example a method of enabling a user to earn reward points, comprises providing a graphical user interface including a plurality of cards, wherein each of the plurality of cards is associated with an item of content and wherein each of the plurality of cards includes a point value and an associated action required to earn the point value, wherein the graphical user interface is presented to a user upon a user selecting an earn points card from a graphical user interface including a profile card, a earn points card, and a redeem card, and updating an account associated with the user upon an associated action being completed. In one example, the method further comprises enabling a user to select one of a profile card, a earn points card, and a redeem card using left and right scrolling commands. In one example, an associated action includes one or more of: watching a latest episode of a television series, watching any episode of a television series, watching any episode included within a season of a television series, and watching a first episode of a television series. In one example, each of the plurality of cards associated with an item of content includes an image associated with an item of content. In one example, the profile card includes one or more of a user identifier, a level status indicator, a medal earned indicator, and a points available indicator. In one example, wherein the earn points card includes featured items of content. In one example, the rewards card includes featured rewards.

As described herein, in one example a method of enabling a user to redeem reward points, comprises providing a graphical user interface including a plurality of cards, wherein each of the plurality of cards is associated with a reward and wherein each of the plurality of cards includes a point value required for a reward, a total number of available points, and a number of additional points required to receive the reward and upon a user selecting a card associated with a reward, providing a graphical user interface providing more information associated with the reward. In one example, more information associated with the reward includes available bonus rewards, wherein bonus rewards are associated with a user level. In one example, the graphical user interface including a plurality of cards associated with a reward is presented to a user upon a user selecting a redeem card from a graphical user interface including a profile card, a earn points card, and a redeem card. In one example, the graphical user interface including a profile card, a earn points card, and a redeem card is presented to a user upon a user selecting an icon representing a rewards application from a stack structure or selecting a pane associated with a rewards application from a plurality of panes.

As described herein, in one example an apparatus for enabling a user to earn and redeem rewards, comprises means for providing a graphical user interface including a profile card, an earn points card, and a redeem card, means for providing a graphical user interface including one or more cards associated with an item of content, wherein each of the one or more cards associated with an item of content include a point value and an associated action required to earn the point value, wherein the graphical user interface is presented to a user upon a user selecting the earn points card, and means for providing a graphical user interface including one or more cards associated with a reward, wherein each of the one or more cards associate with a reward include a point value required for a reward, a total number of available points, and a number of additional points required to receive the reward. In one example, the apparatus further comprising means enabling a user to select one of more cards included in a graphical user interface using left and right scrolling commands. In one example, the profile card includes one or more of a user identifier, a level status indicator, a medal earned indicator, and a points available indicator. In one example, the earn points card includes featured items of content, and the redeem card includes featured rewards. In one example an associated action required to earn the point value includes watching a particular episode of a television series. In one example, the graphical user interface including one or more cards associated with a reward enables user to cause a graphical user interface including more information associated with a reward to be presented. In one example, the graphical user interface including more information associated with a reward includes one or more icons associated with a respective purchase option. In one example, a purchase option includes a purchase with bonuses option. In one example, the graphical user interface including more information associated with a reward includes a bonus description for each of a plurality of respective levels.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, which is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a mark-up language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method of enabling a user to earn reward points, the method comprising:
providing a graphical user interface including a plurality of cards, wherein each of the plurality of cards is associated with an item of content and wherein each of the plurality of cards includes a point value and an associated action required to earn the point value, wherein the graphical user interface is presented to a user upon a user selecting an earn points card from a graphical user interface including a profile card, an earn points card, and a redeem card; and
updating an account associated with the user upon an associated action being completed.

2. The method of claim 1, further comprising enabling a user to select one of a profile card, a earn points card, and a redeem card using left and right scrolling commands.

3. The method of claim 1, wherein an associated action includes one or more of: watching a latest episode of a television series, watching any episode of a television series, watching any episode included within a season of a television series, and watching a first episode of a television series.

4. The method of claim 3, wherein each of the plurality of cards associated with an item of content includes an image associated with an item of content.

5. The method of claim 1, wherein the profile card includes one or more of a user identifier, a level status indicator, a medal earned indicator, and a points available indicator.

6. The method of claim 1, wherein the earn points card includes featured items of content.

7. The method of claim 1, wherein the rewards card includes featured rewards.

8. A method of enabling a user to redeem reward points, the method comprising:
providing a graphical user interface including a plurality of cards, wherein each of the plurality of cards is associated with a reward and wherein each of the plurality of cards includes a point value required for a reward, a total number of available points, and a number of additional points required to receive the reward; and
upon a user selecting a card associated with a reward, providing a graphical user interface providing more information associated with the reward.

9. The method of claim 8, wherein more information associated with the reward includes available bonus rewards, wherein bonus rewards are associated with a user level.

10. The method of claim 8, wherein the graphical user interface including a plurality of cards associated with a reward is presented to a user upon a user selecting a redeem card from a graphical user interface including a profile card, a earn points card, and a redeem card.

11. The method of claim 10, wherein the graphical user interface including a profile card, a earn points card, and a redeem card is presented to a user upon a user selecting an icon representing a rewards application from a stack structure or selecting a pane associated with a rewards application from a plurality of panes.

12. An apparatus for enabling a user to earn and redeem rewards, the apparatus comprising:
means for providing a graphical user interface including a profile card, an earn points card, and a redeem card;
means for providing a graphical user interface including one or more cards associated with an item of content, wherein each of the one or more cards associated with an item of content includes a point value and an associated action required to earn the point value, wherein the graphical user interface is presented to a user upon a user selecting the earn points card; and
means for providing a graphical user interface including one or more cards associated with a reward, wherein each of the one or more cards associated with a reward include a point value required for a reward, a total number of available points, and a number of additional points required to receive the reward.

13. The apparatus of claim 12, further comprising means enabling a user to select one of more cards included in a graphical user interface using left and right scrolling commands.

14. The apparatus of claim 12, wherein the profile card includes one or more of a user identifier, a level status indicator, a medal earned indicator, and a points available indicator.

15. The apparatus of claim 14, wherein the earn points card includes featured items of content, and the redeem card includes featured rewards.

16. The apparatus of claim 12, wherein an associated action required to earn the point value includes watching a particular episode of a television series.

17. The apparatus of claim 12, wherein the graphical user interface including one or more cards associated with a reward enables user to cause a graphical user interface including more information associated with a reward to be presented.

18. The apparatus of claim 17, wherein the graphical user interface including more information associated with a reward includes one or more icons associated with a respective purchase option.

19. The apparatus of claim 18, wherein a purchase option includes a purchase with bonuses option.

20. The apparatus of claim 19, where the graphical user interface including more information associated with a reward includes a bonus description for each of a plurality of respective levels.
